(19) United States
(12) Patent Application Publication
(10) Pub. No.: US 2014/0032732 A1
(43) Pub. Date: Jan. 30, 2014

(54) SYSTEM FOR ACCOUNT SETUP AND/OR DEVICE INSTALLATION

(71) Applicant: Ingersoll-Rand Company, Davidson, NC (US)

(72) Inventors: Stephanie Raye Cox, Westfield, IN (US); Paul Joseph Hoggard, Carmel, IN (US); Dustin Gregory Sanders, Westfield, IN (US); Bruce Wayne Schaffer, Carmel, IN (US)

(21) Appl. No.: 13/953,509

(22) Filed: Jul. 29, 2013

Related U.S. Application Data
(60) Provisional application No. 61/676,805, filed on Jul. 27, 2012.

(51) Int. Cl. H04L 12/24

(52) U.S. Cl. CPC H04L 41/0806
USPC 709/223

(57) ABSTRACT

A user may select more than one device to be installed in a building. An order of installation of the devices may be determined based on the type of devices selected. A user may be presented with a module for each device selected. The modules may be presented in the order of installation. The modules may include instructions for installation for the corresponding device.

### CROSS-REFERENCE TO RELATED APPLICATIONS

The present application claims the benefit of U.S. Provisional Patent Application No. 61/676,805, filed Jul. 27, 2012, which is hereby by incorporated by reference in its entirety.

### BACKGROUND

The present invention generally relates to setting up an account and/or installing devices in a network, and more particularly, but not exclusively, relates to setting up an account and/or installing devices in a home intelligence system.

New account setup and device installation processes may present various information to a user. Some existing systems have various shortcomings relative to certain applications. Accordingly, there remains a need for further contributions in this area of technology.

### SUMMARY

One embodiment of the present application is a unique account setup and/or device installation system. Other embodiments include apparatuses, systems, devices, hardware, methods, and combinations for setting up accounts and/or installing devices. Further embodiments, forms, features, aspects, benefits, and advantages of the present application shall become apparent from the description and figures provided herewith.

### BRIEF DESCRIPTION OF THE FIGURES

The description herein makes reference to the accompanying figures wherein like reference numerals refer to like parts throughout the several views, and wherein:

FIG. 1 is a schematic diagram of an exemplary system.

FIG. 2 is a schematic diagram of an exemplary computer.

FIG. 3 is a schematic diagram of an exemplary processing subsystem.

FIG. 3A is a schematic flow diagram of an exemplary technique.

FIG. 4 is a schematic flow diagram of an exemplary technique.

FIGS. 5A-5H are a schematic flow diagram of another exemplary technique.

FIGS. 6A-6G are a schematic flow diagram of another exemplary technique.

FIG. 7 illustrates an exemplary login page.

FIG. 8 illustrates an exemplary terms and conditions page.

FIG. 9 illustrates an exemplary account setup page.

FIG. 10 illustrates another exemplary account setup page.

FIG. 11 illustrates an exemplary account confirmation page.

FIG. 12 illustrates an exemplary confirmation email.

FIG. 13 illustrates an exemplary account login page.

FIG. 14 illustrates an exemplary add home page.

FIG. 15 illustrates an exemplary enrollment cart page.

FIG. 16 illustrates an exemplary enrollment cart confirmation page.

FIG. 17 illustrates an exemplary getting started page.

FIG. 18 illustrates an exemplary device enrollment instruction page.

FIG. 19 illustrates an exemplary enrollment confirmation page.

FIGS. 20-23 illustrate an exemplary bridge module.

FIGS. 24-26 illustrate an exemplary light module.

FIGS. 27-29 illustrate an exemplary thermostat module.

FIGS. 30-32 illustrate an exemplary lock module.

FIGS. 33-34 illustrate an exemplary sensor module.

FIGS. 35-37 illustrate an exemplary camera module.

FIGS. 38-40 illustrate an exemplary XL 950 module.

FIG. 41 illustrates an exemplary add device page.

FIGS. 42-45 illustrate exemplary billing pages.

FIG. 46 illustrates an exemplary welcome page.

### DETAILED DESCRIPTION OF REPRESENTATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

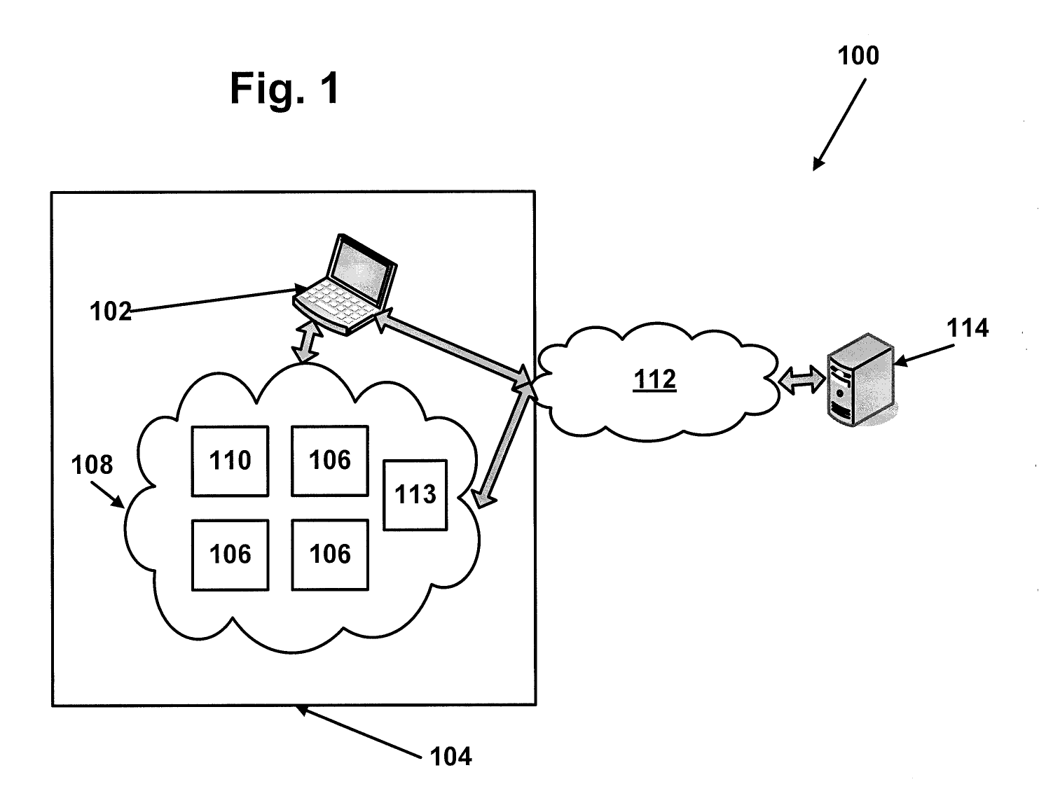

FIG. 1 illustrates a system 100 including a computer 102 in a building 104 such as a home (e.g., a single family or multi-family residence) and/or a commercial office building. The building 104 may include one or more home automation devices 106 such as control locks, light control modules, thermostats, sensors, appliance modules, and cameras to name a few. The automation devices 106 are generally connected to a network 108 with a bridge 110. It is contemplated that in some embodiments, some devices 106 are connected to the network 108 or the Internet without a bridge 110. The automation devices 106 may be controlled with the computer 102, which may be a computer, a tablet, smart phone, or any other type of computing device. The computer 102 may communicate with the automation devices 106 via the bridge 110, which may be connected to the Internet 112. Thus, the computer 102 may communicate with the automation devices 106 generally from any location that has an Internet connection. Various forms of communication between the computer 102 and the devices 106 are contemplated. For example, the computer 102 may, among other forms of communication, control, request or gather information from, or send information to the devices 106.

There may be more than one network 108 at the building 104. For example, the building 104 may include a router 113 that is connected to the Internet. The bridge 110 may form a mesh network with some of the automation devices 106. The bridge 110 may be connected to the Internet through the router 113, which allows the automation devices 106 that are part of the mesh network to be connected to the Internet. Other automation devices 106 may connect to the Internet by communicating directly with the router 113 at the building 104. The one or more networks 108 may be network(s) that includes technologies such as Z-Wave and Wi-Fi, among others. The computer 102 may communicate with the automation devices 106 through the Internet using either the router 113 and/or bridge 110.

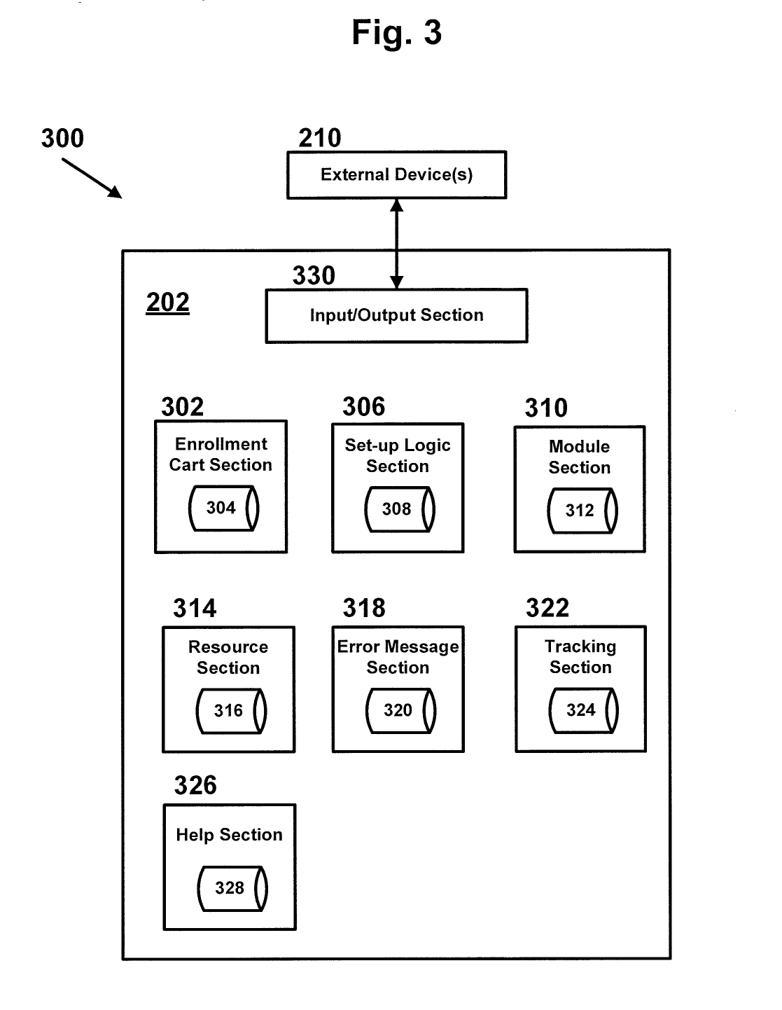

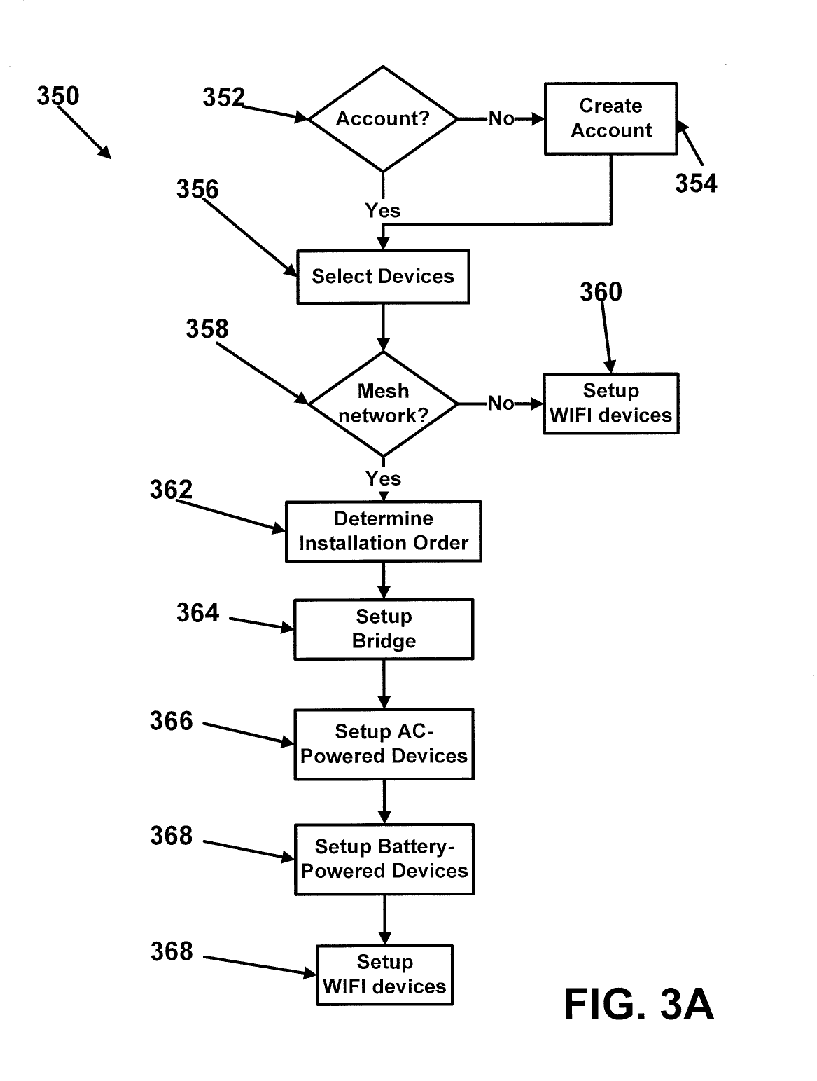

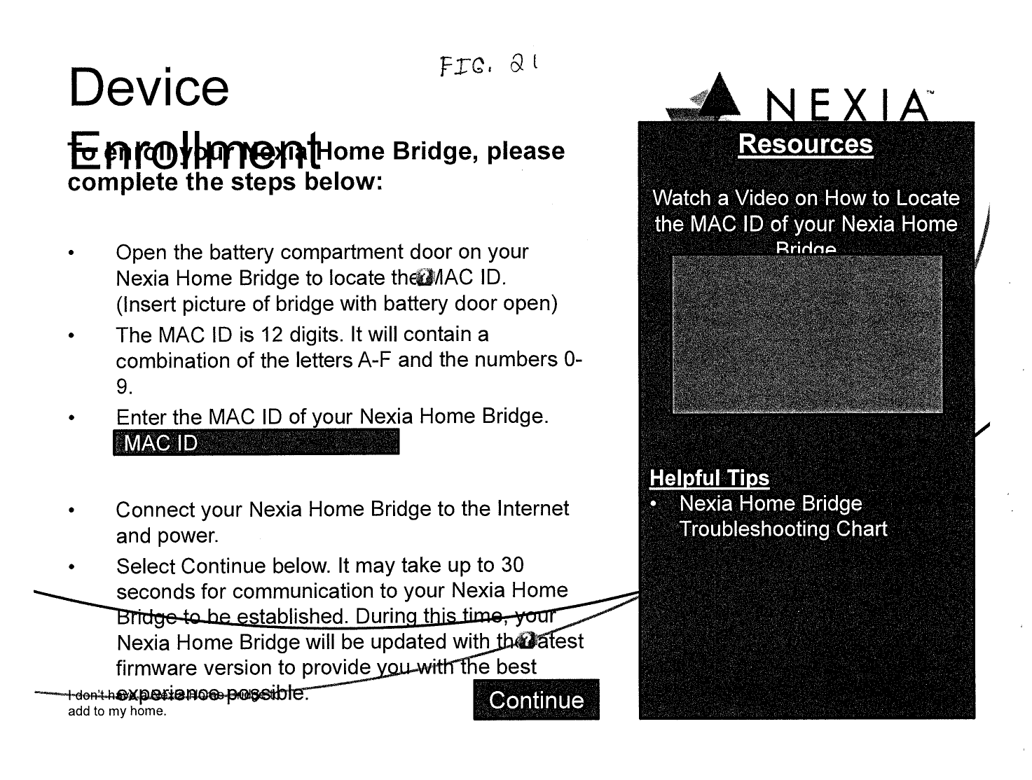

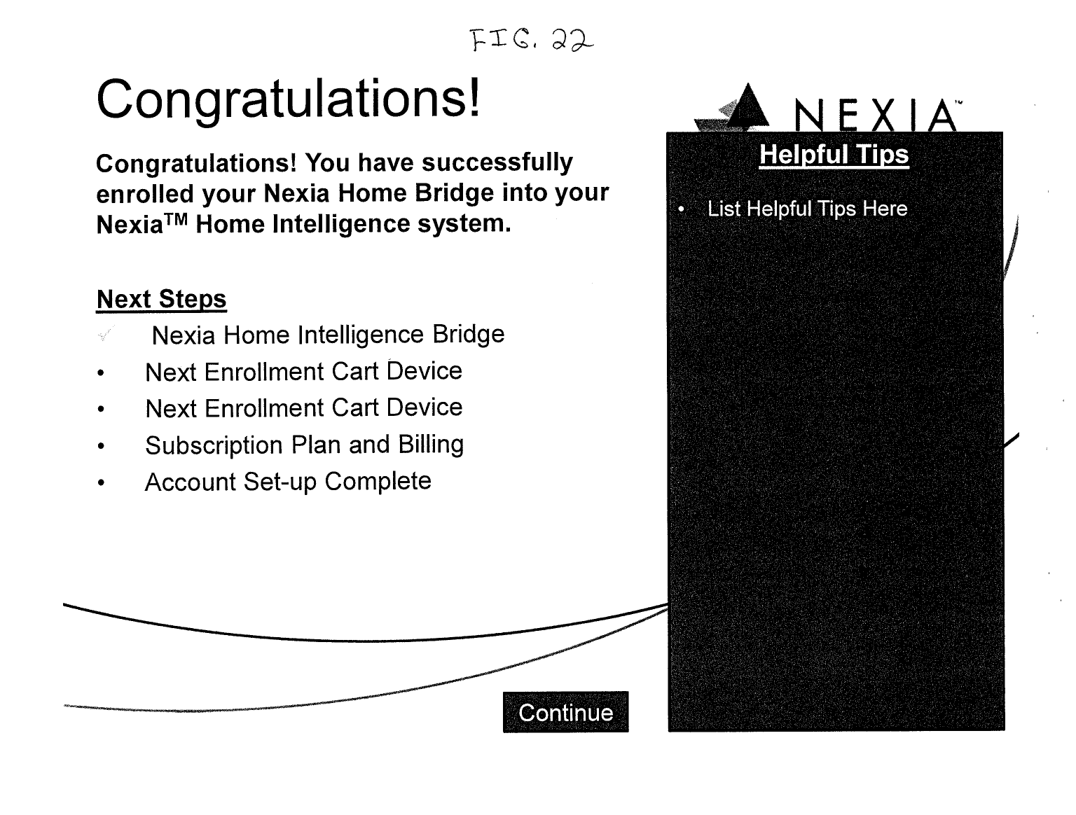

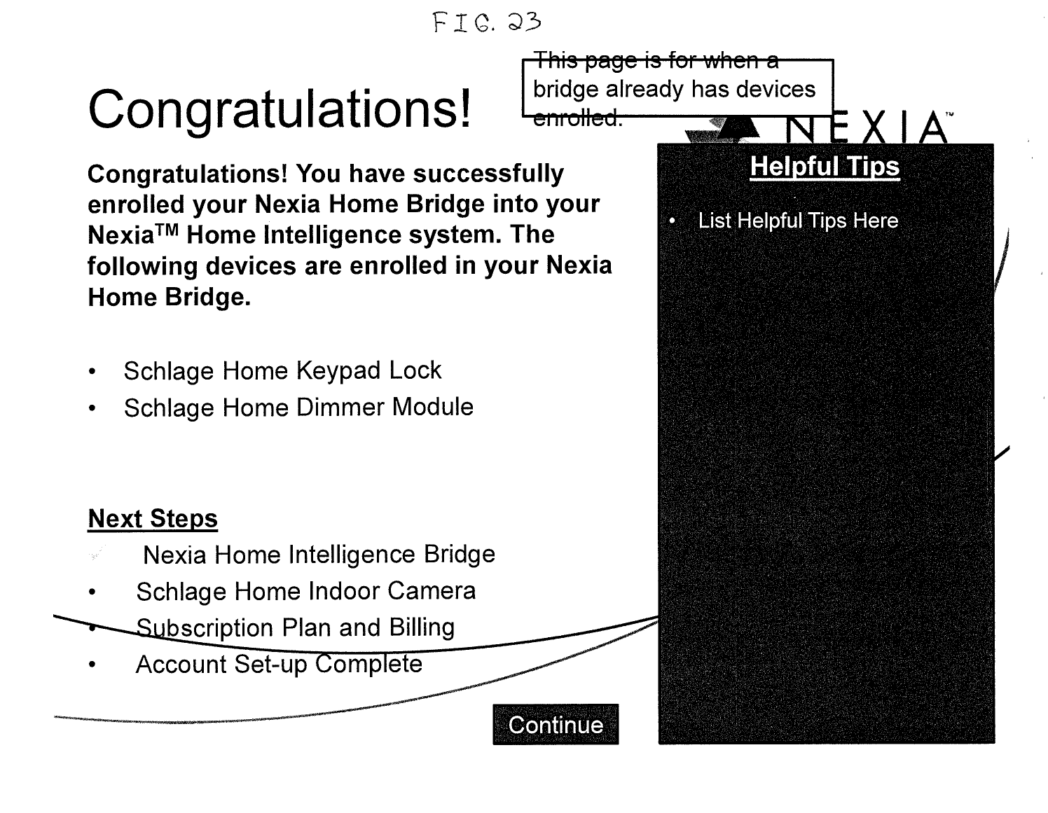

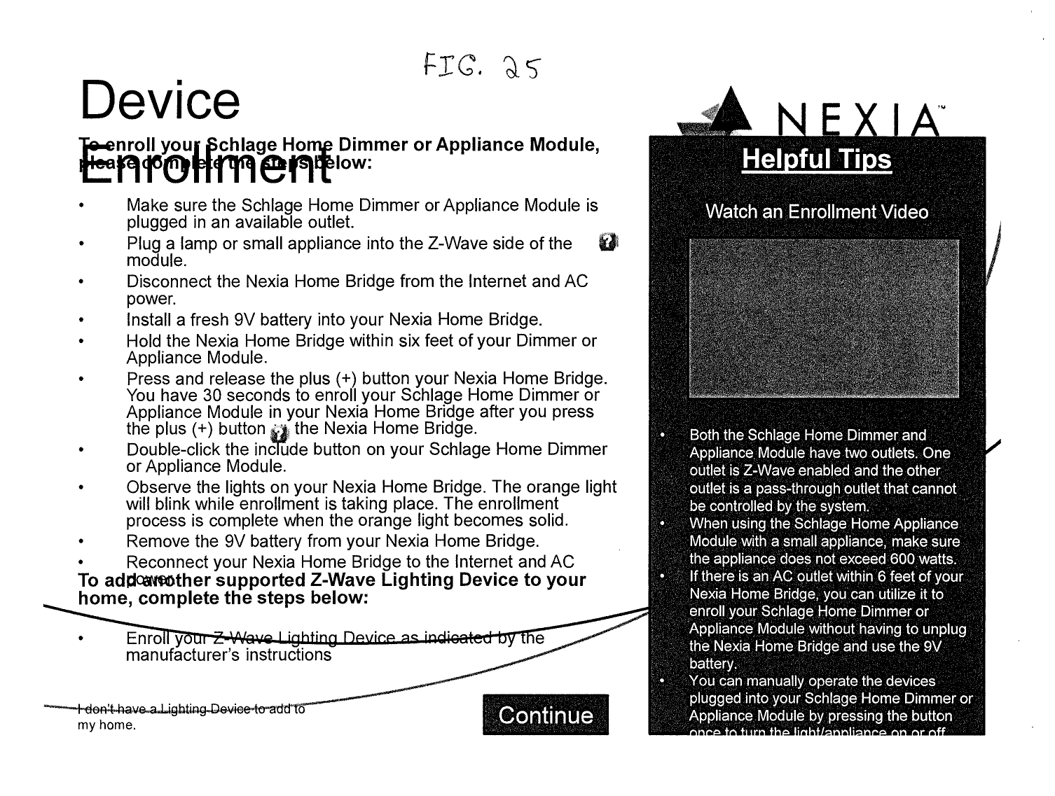

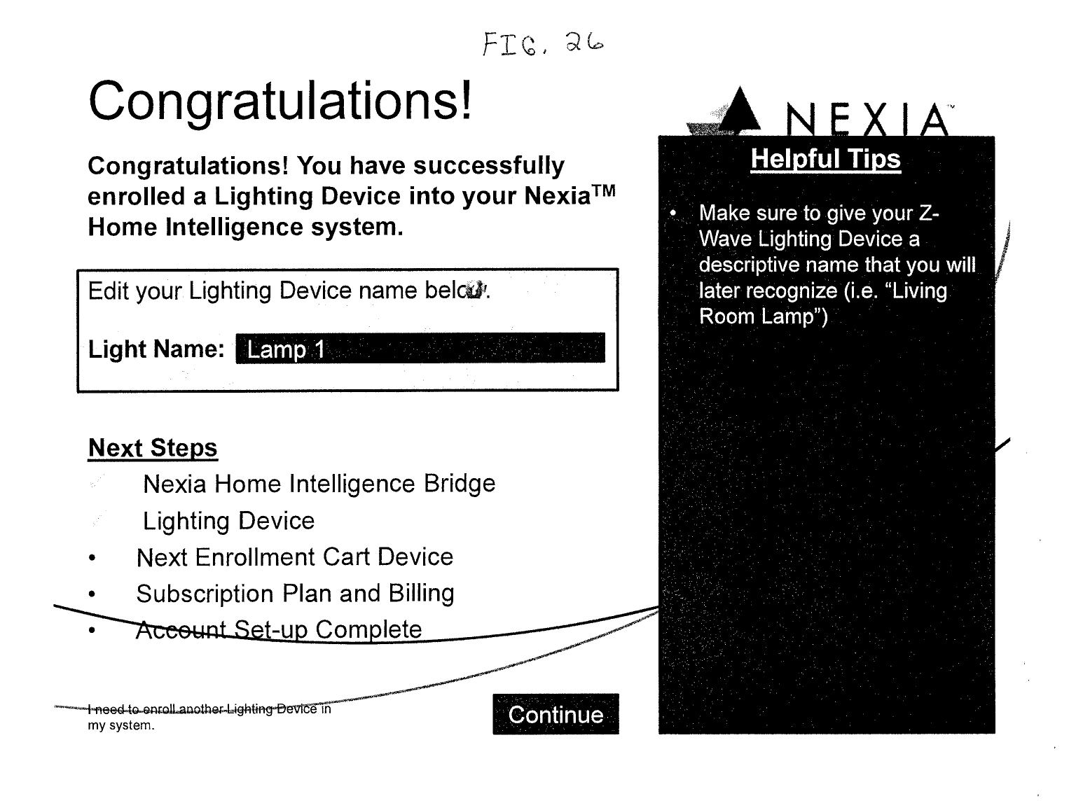

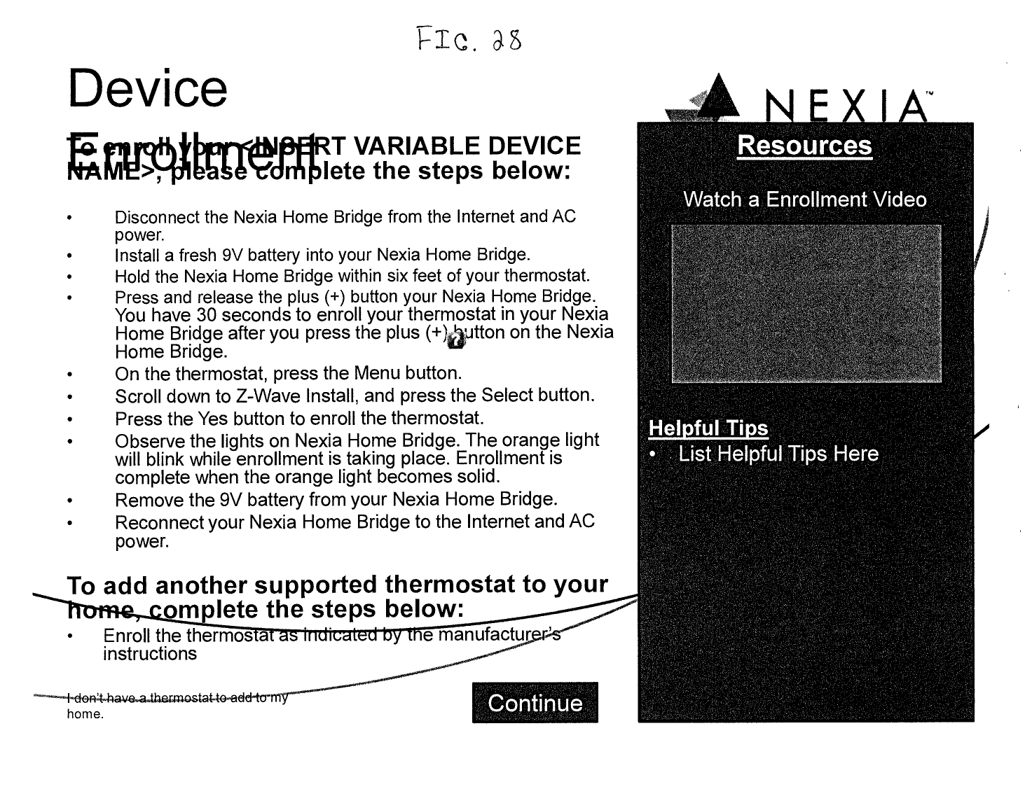

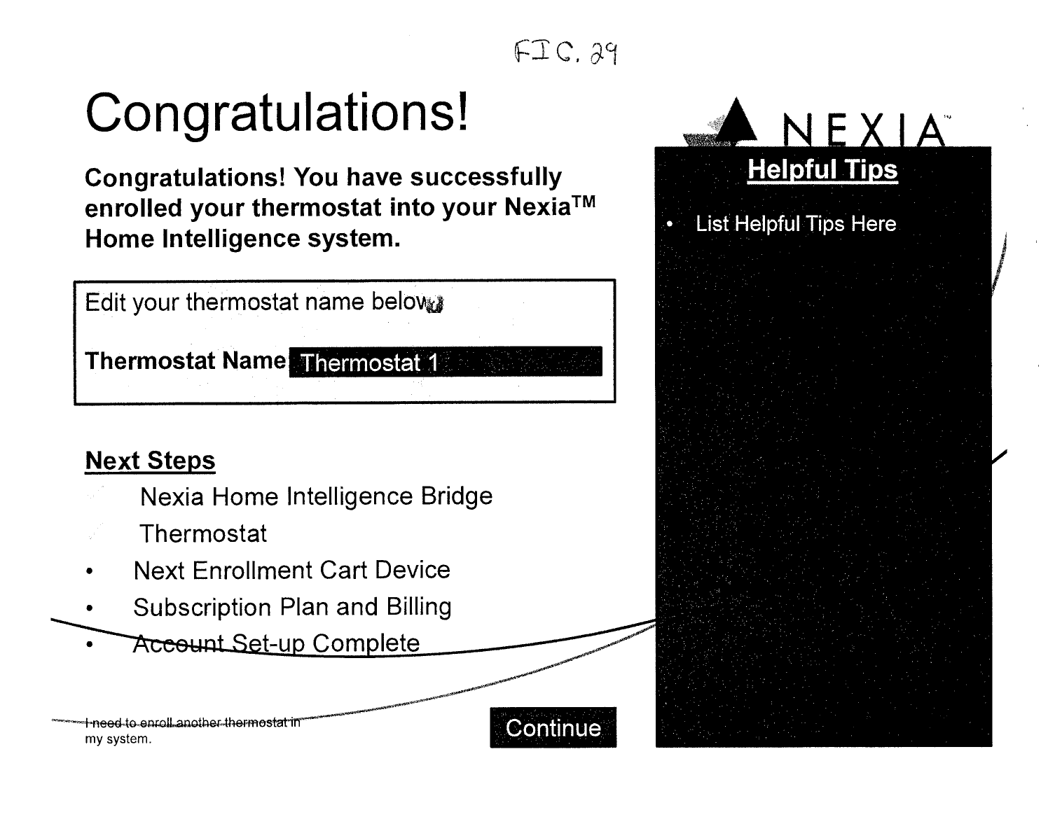

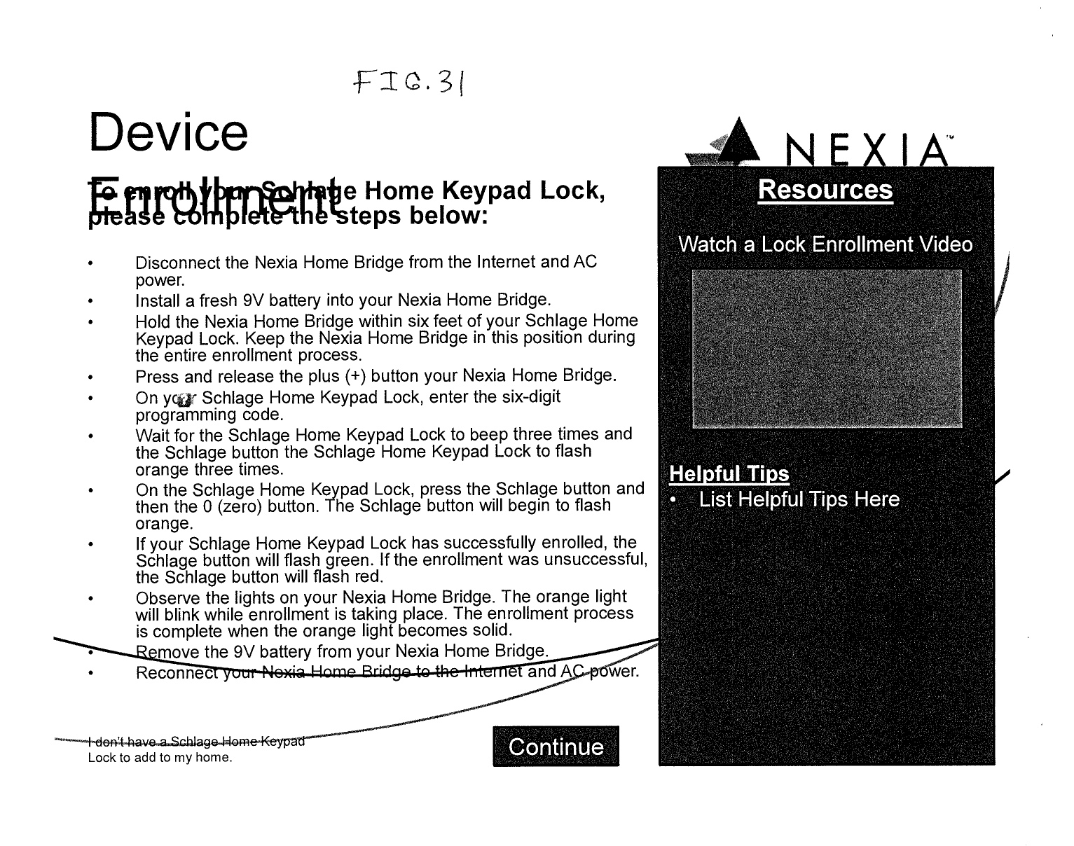

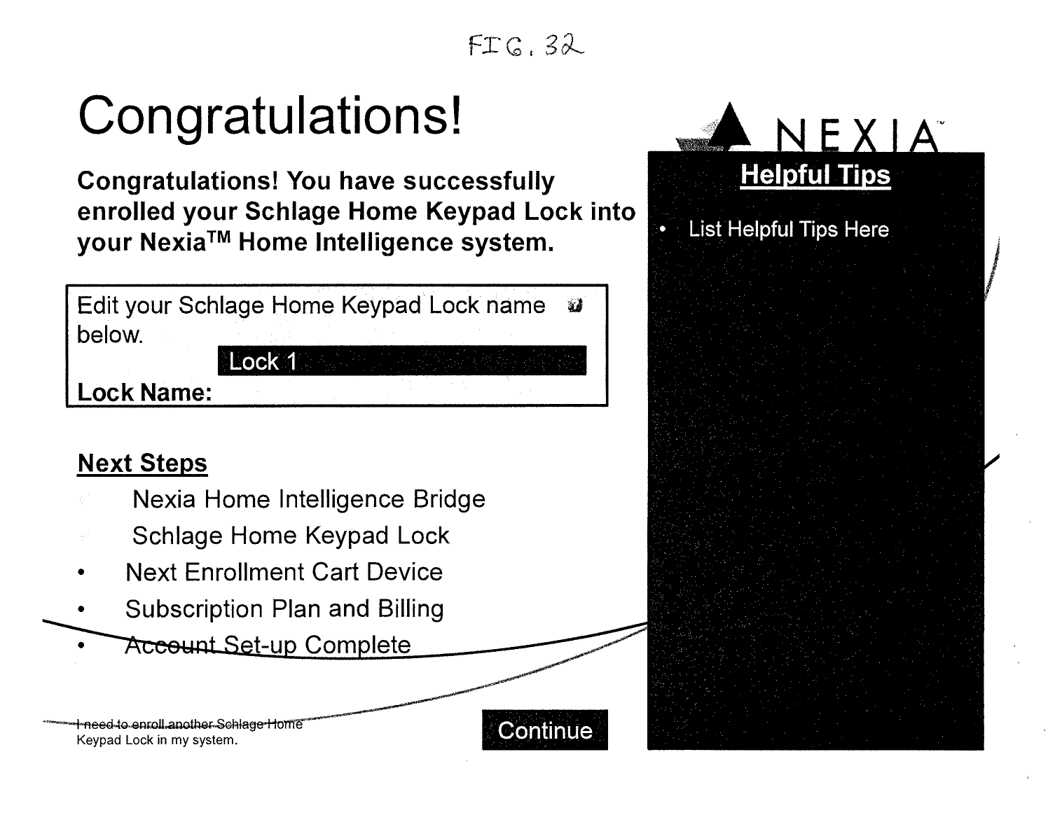

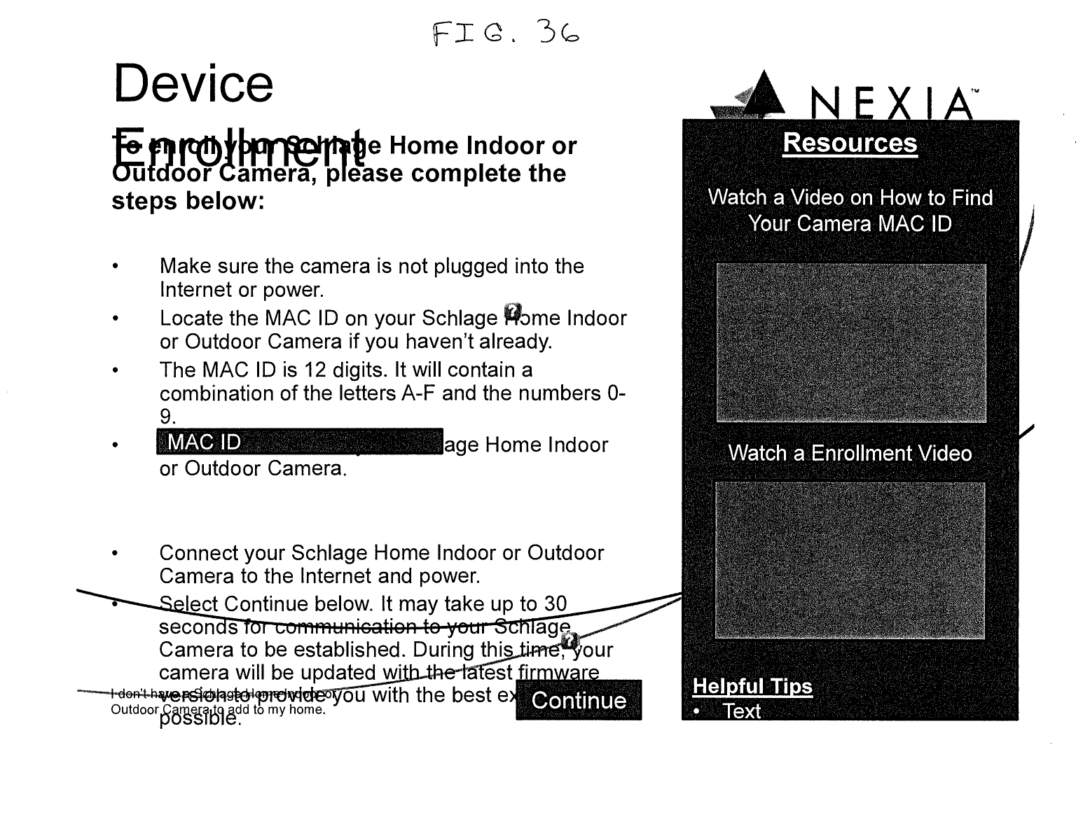

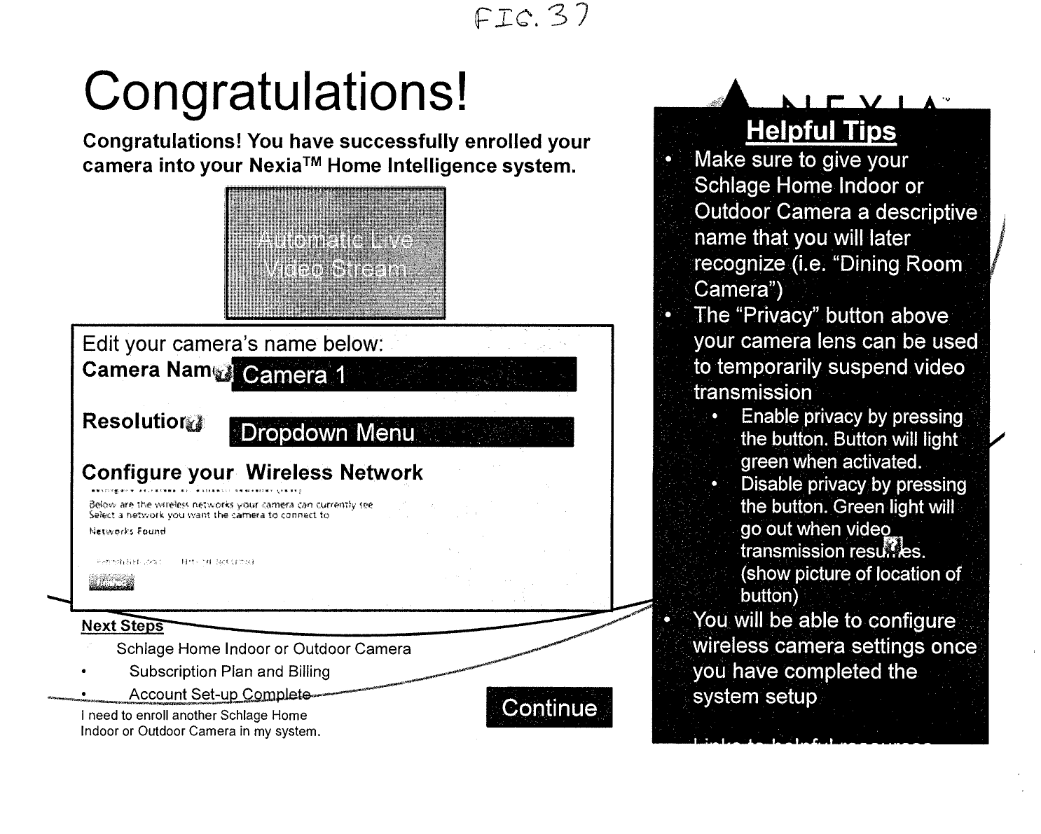

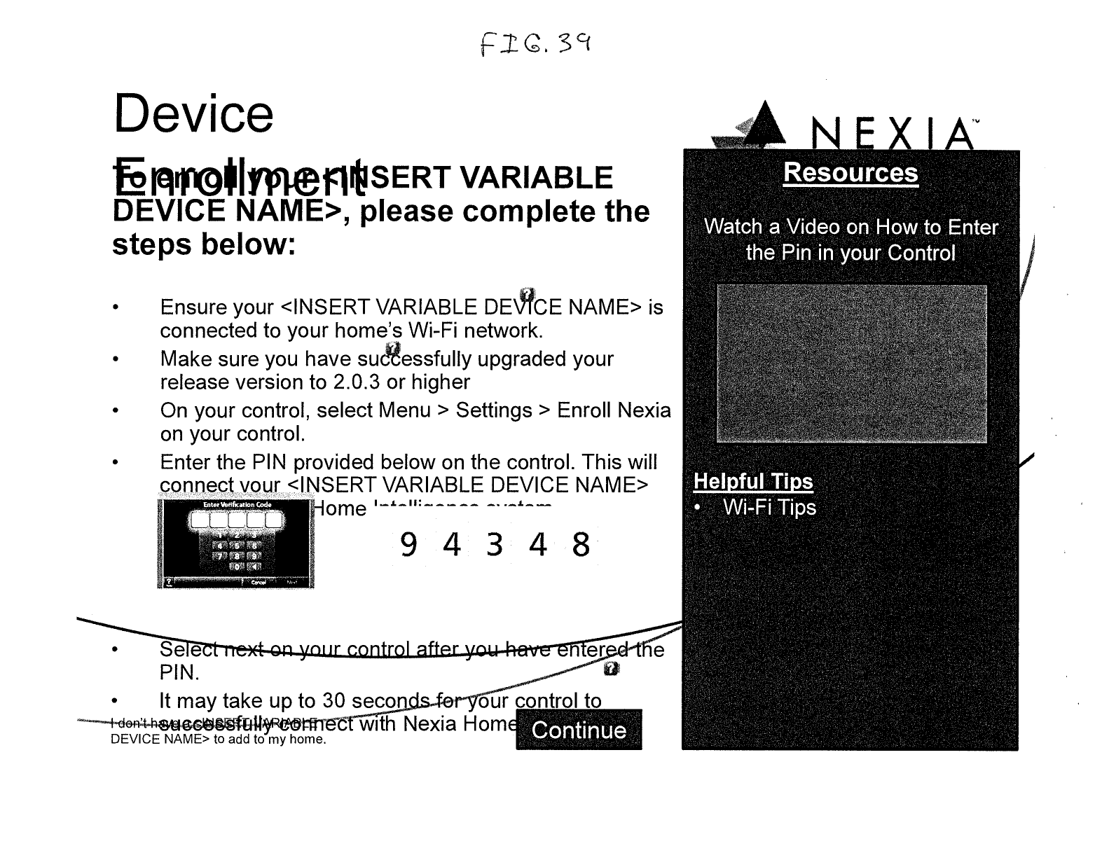

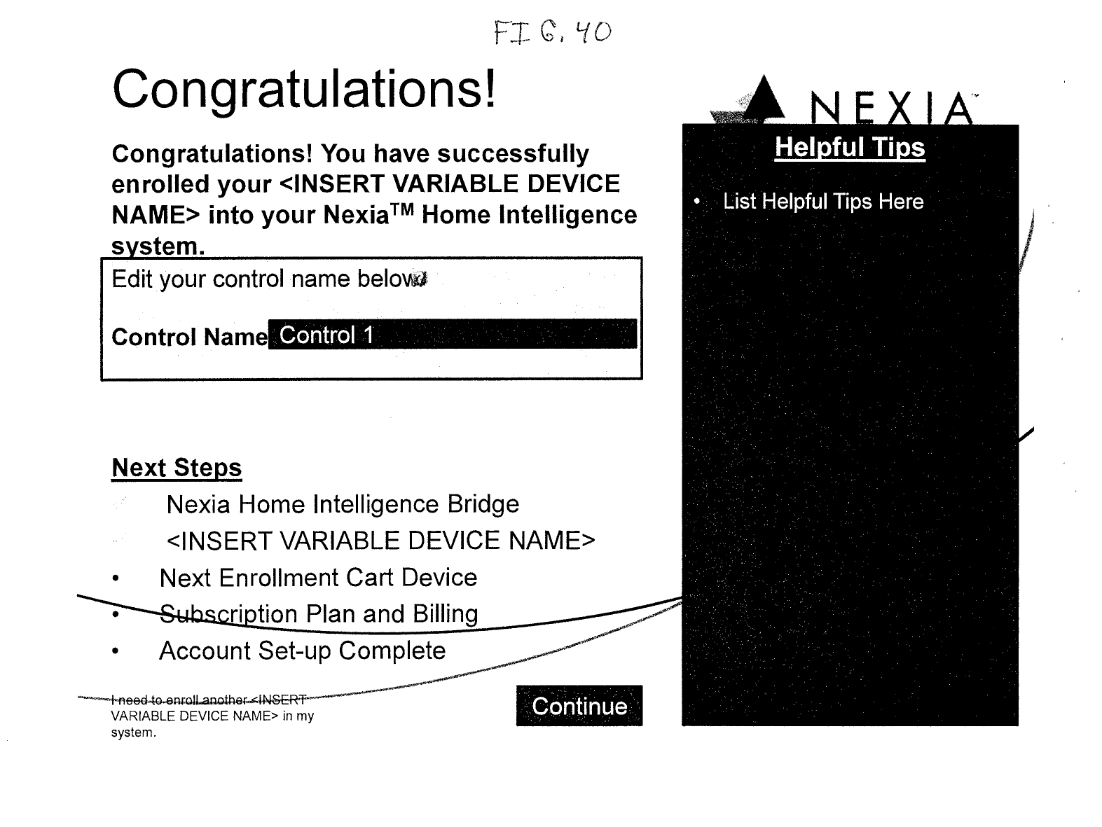

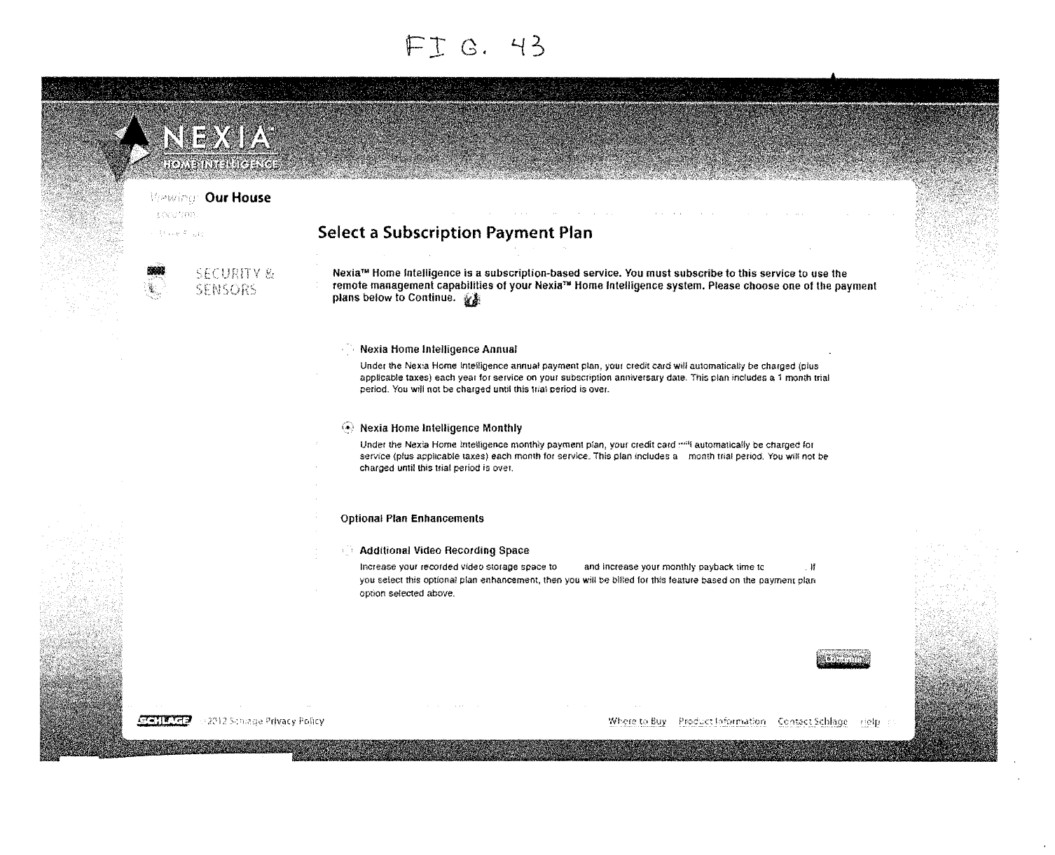

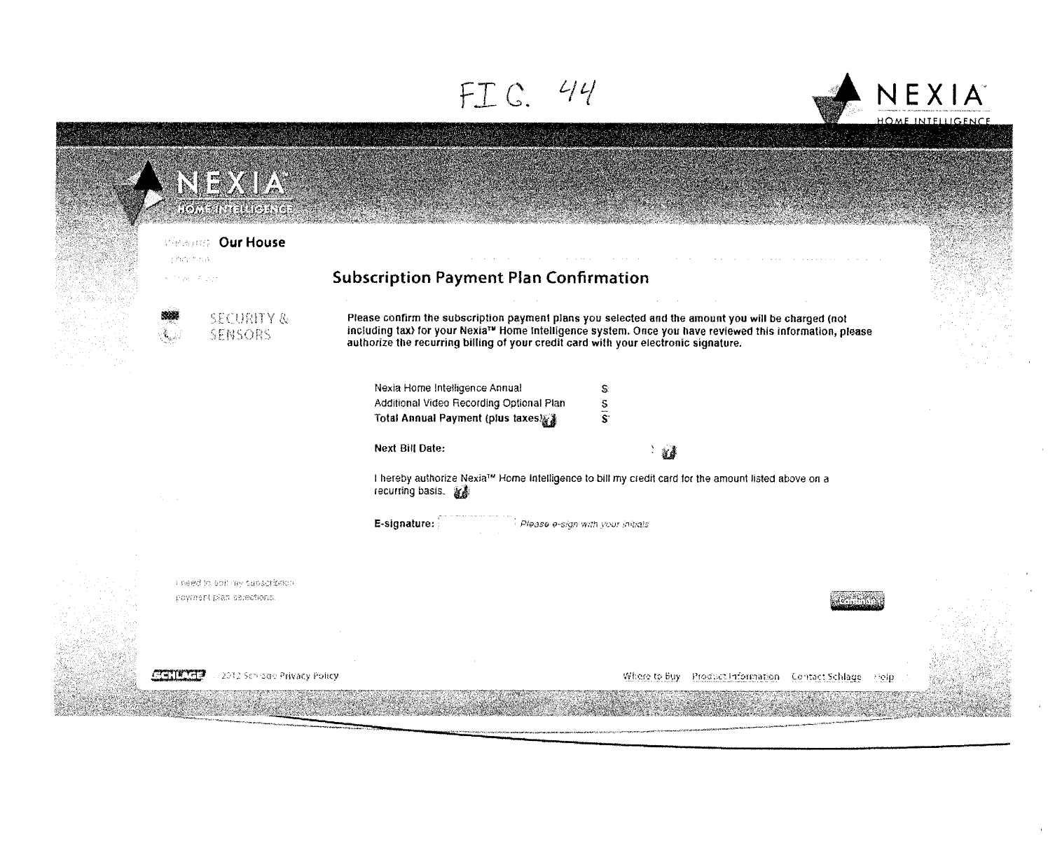

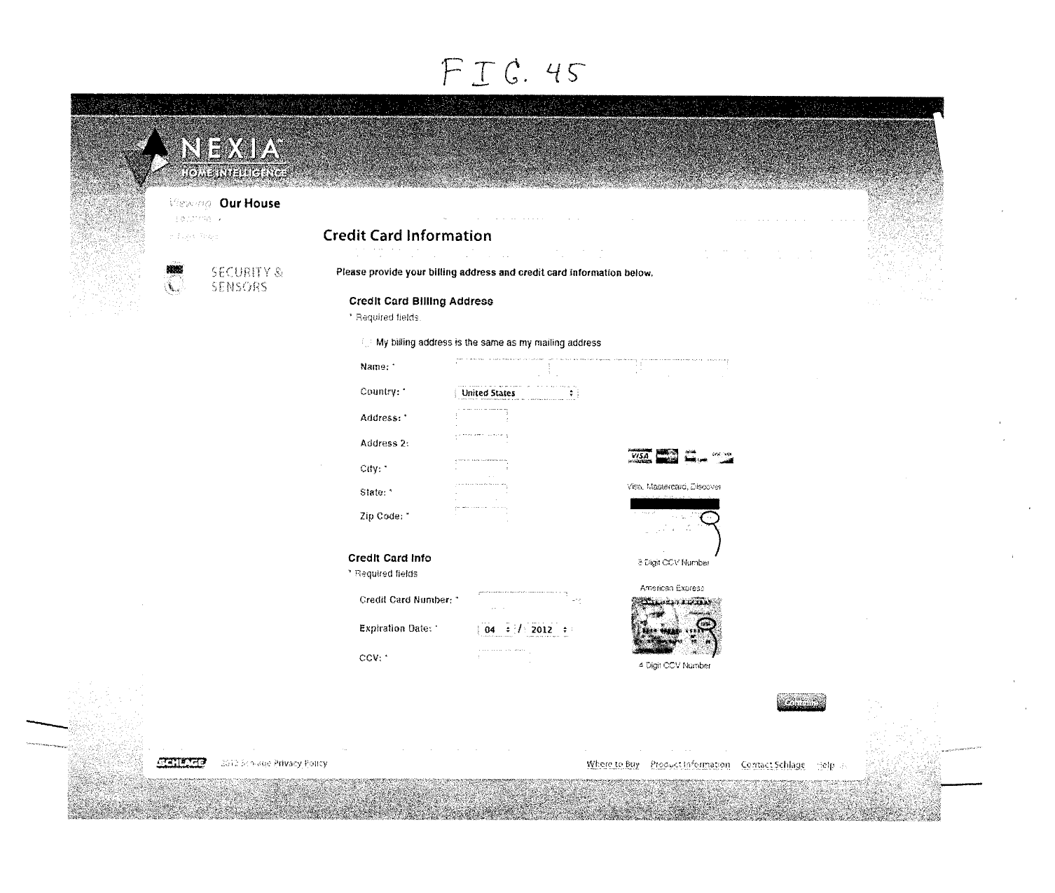

When a customer purchases one or more automation devices 106 for installation, the customer may use a configuration process that can include a new account and/or installation process to install the devices in a network 108, as described below and shown in FIGS. 3-46. The new account setup and/or device installation process may be used with any automation services such as the NEXIA Home Intelligence or Nexia Pro Intelligenceautomation service.

In the new account setup and/or device installation process of the present application, each customer is walked through a customized setup process based on the devices 106 they choose for their building 104 such as a home. Logic 308, part of a logic section 306, which is described in more detail below, determines the order each device 106 is presented during the process to so that the consumer is creating a relatively robust network 108, such as, but not limited to, a Z-Wave network. The setup process includes one or more modules 312 for each of the compatible automation devices 106. The modules 312 walk the consumer through all aspects of setting up the devices 106 physically installed and enrolled in the system 100.

The computer 102 may be used to setup the account and/or install devices 106 in the network 108. The computer 102 may communicate with a server 114, via the Internet 112, that provides the building automation services. The server 114 may also communicate with the bridge 110, via the Internet 112, to provide the automation services. For example, the server 114 may provide an interface for a user of the computer 102 to use for setting up and configuring the automation devices 106 in the building 104. The server 114 may send commands and/or configuration information to the automation devices 106 whether they are connected directly to the Internet via router 113 or connected via the bridge 110.

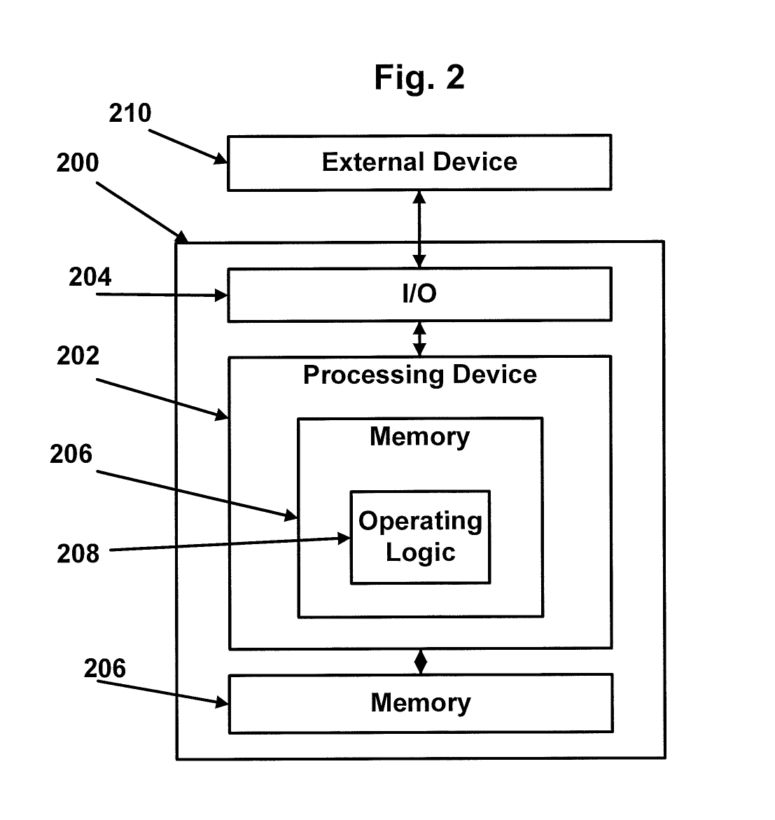

FIG. 2 is a schematic diagram of a computer 200. Examples of the computer 200 include the computer 102 and the server 114 shown in FIG. 1. Computer 200 includes a processing device 202, an input/output device 204, memory 206, and operating logic 208. Furthermore, computer 200 communicates with one or more external devices 210.

The input/output device 204 may be any type of device that allows the computer 200 to communicate with the external device 210. For example, the input/output device may be a network adapter, network card, or a port (e.g., a USB port, serial port, parallel port, VGA, DVI, HDMI, FireWire, CAT 5, or any other type of port). The input/output device 204 may be comprised of hardware, software, and/or firmware. It is contemplated that the input/output device 204 includes more than one of these adapters, cards, or ports.

The external device 210 may be any type of device that allows data to be inputted or outputted from the computer 200. For example, the external device 210 may be another computer, a server 114, an automation device 106, a bridge 110, router 113, a printer, a display, an alarm, an illuminated indicator, a keyboard, a mouse, mouse button, or a touch screen display. Furthermore, it is contemplated that the external device 210 may be integrated into the computer 200. For example, the computer 200 may be a smartphone, a laptop computer, or a tablet computer in which case the display would be an external device 210, but the display is integrated with the computer 200 as one unit, which consistent with the general design of smartphones, laptop computers, tablet computers, and the like. It is further contemplated that there may be more than one external device in communication with the computer 200.

Processing device 202 can be of a programmable type, a dedicated, hardwired state machine, or a combination of these; and can further include multiple processors, Arithmetic-Logic Units (ALUs), Central Processing Units (CPUs), or the like. For forms of processing device 202 with multiple processing units, distributed, pipelined, and/or parallel processing can be utilized as appropriate. Processing device 202 may be dedicated to performance of just the operations described herein or may be utilized in one or more additional applications. In the depicted form, processing device 202 is of a programmable variety that executes algorithms and processes data in accordance with operating logic 208 as defined by programming instructions (such as software or firmware) stored in memory 206. Alternatively or additionally, operating logic 208 for processing device 202 is at least partially defined by hardwired logic or other hardware. Processing device 202 can be comprised of one or more components of any type suitable to process the signals received from input/output device 204 or elsewhere, and provide desired output signals. Such components may include digital circuitry, analog circuitry, or a combination of both.

Memory 206 may be of one or more types, such as a solid-state variety, electromagnetic variety, optical variety, or a combination of these forms. Furthermore, memory 206 can be volatile, nonvolatile, or a mixture of these types, and some or all of memory 206 can be of a portable variety, such as a disk, tape, memory stick, cartridge, or the like. In addition, memory 206 can store data that is manipulated by the operating logic 208 of processing device 202, such as data representative of signals received from and/or sent to input/output device 204 in addition to or in lieu of storing programming instructions defining operating logic 208, just to name one example. As shown in FIG. 2, memory 206 may be included with processing device 202 and/or coupled to the processing device 202.

FIG. 3 is a schematic block diagram of an exemplary processing subsystem 300 for setting up a new account and/or installing devices 106 in a network 108. The processing subsystem 300 includes a processing device 202 that may be part of a computer 200 such as server 114. The processing device 202 includes sections configured to provide multiple functionalities relating to the modules 312, resources 316, error messages 320, and/or tooltips 328 as well as providing other functionalities. The exemplary embodiments described herein may include a number of sections providing a number of functionalities. A section may be implemented in operating logic 208 as operations by software, hardware, artificial intelligence, fuzzy logic, or any combination thereof, or at least partially performed by a user or operator. In certain embodiments, sections represent software elements as a computer program encoded on a computer readable medium, wherein a computer performs the described operations when executing the computer program.

A section may be a single device, distributed across devices, and/or a section may be grouped in whole or in part with other sections or devices. For example, when a customer uses a computer 102 to setup an account and configure the network 108 of devices 106, the computer 102 may display the modules 312, resources 314, error messages 320, tooltips 328, pages, and/or screens. The modules 312 (which may include web pages and/or screens), resources 314, error messages 320, and tooltips 328, may be part of software and/or hardware on the computer 102 or may be hosted by the server 114 via the Internet 112 and displayed on the computer 102, or some combination thereof. The operations of any section may be performed wholly or partially in hardware/software or by other sections. The presented organization of the sections is exemplary only, and other organizations, configurations and arrangements are contemplated.

The processing subsystem 300 may include an enrollment cart section 302 that allows a customer to select the devices 106 to be installed and configured in the home 104. The enrollment cart section 302 displays an enrollment cart 304 on a computer 102 that allows customers to select the products they want to setup on their building 104 such as a home. The enrollment cart section 302 allows for each customer to have a customized account setup experience based on the devices 106 they have purchased for their home 104. The enrollment cart section 302 may also include an interface for the customer to create an account if the customer does not have an account. In creating an account, the customer may enter information about the building 104 and/or the network 108 (e.g., MAC ID or MAC address of the bridge 110), among other data.

The processing system 300 may include a setup logic section 306, which determines the order in which devices 106 (such as Z-Wave and Wi-Fi enabled devices) should be installed and enrolled to create a network 108, such as mesh network, in the building 104. The setup logic section 306 may include logic 308 that, based on the devices 106 selected in the enrollment cart 304, determines the best installation and enrollment path for each customer and displays the appropriate device modules 306 in that order. This logic 308 generally results in providing each customer with a unique experience.

In one non-limiting example, the setup logic section 306, including logic 308, may determine the installation sequence of several devices 106 such as devices A, B, C, D. Moreover, the setup logic section 306 may determine that the proper installation sequence of should be B, D, A, C to provide the best installation results.

In a mesh network, such as a Z-Wave network, the setup logic 306 will typically instruct the customer to install and/or configure the bridge 110 before installing and configuring the automation devices 106. The setup logic section 306 may categorize the automation devices 106 into more one or more categories to determine the installation sequence. For example, the setup logic 306 may categorize the devices 106 into a WIFI category and a mesh network category. For devices 106 to be installed in a mesh network there may be two subcategories: AC-powered devices and battery-powered devices. Within the two subcategories AC-powered devices and battery-powered devices the setup logic section 306 may further determine the order of installation and/or configuration.

If a user selects light control modules, an appliance module, a thermostat, a sensor, and a lock to be installed, e.g., in a mesh network, the setup logic section 306 will typically categorize the light control modules, the appliance module, and the thermostat as AC-powered devices, and the sensor and lock will typically be categorized as battery-powered devices. The setup logic section 306 generally determines the order of installation and/or configuration based on the communication behavior and pattern of each of the automation devices 106 selected. Generally, AC-powered devices will be installed and configured before battery-powered devices because the AC-powered devices typically act as repeaters, which helps build the mesh network once they are installed and/or configured.

The setup logic section 306 will typically have the user setup and install the light control modules first because the light control modules are typically AC-powered, some should be located close to the bridge 110, the light modules are relatively easier to install and/or configure compared to other devices, and the light modules act as repeaters in the mesh network 108, which helps build the mesh network.

Next, the setup logic section 306 will typically have the user setup and install the appliance module second because the appliance module is typically AC-powered, relatively easier to install and/or configure compared to other devices, and the appliance module acts as a repeater in the mesh network 108.

Next, the setup logic section 306 will typically have the user setup and install the thermostat third because the then iostat is typically AC-powered, the thermostat is relatively easier to install and/or configure compared to other devices, and the thermostat acts as a repeater in the mesh network 108. It is contemplated that the setup logic section 306 may determine a different order of installation and/or configuration for the devices 106 in the AC-powered category depending on the particular communication behavior or pattern for each device.

The setup logic section 306 may also determine an order of installation and/or configuration for each device in the battery-powered category. The setup logic section 306 will typically have the user setup and install the lock later in the installation and/or configuration process because the lock is typically battery-powered, is relatively more difficult to install and/or configure compared to other devices, and is typically not a repeater in a mesh network. The setup logic section 306 will typically have the user setup and install any sensors last in the process because sensors are typically battery-powered, are relatively more difficult to install and/or configure, and are typically not repeaters in a mesh network. For example, a customer may only have one chance to install and/or configure a sensor. It may be beneficial for the customer to install and/or configure any sensors last once the rest of the mesh network is properly configured and the customer is comfortable with the process. It is contemplated that the setup logic section 306 may determine a different order of installation and/or configuration for the devices 106 in the battery-powered category depending on the particular communication behavior or pattern for each device.

Generally, the setup logic section 306 is configured to install and/or configure the AC-powered devices first before installing and configured the battery-powered devices. Typically, devices that are AC-powered act as repeaters and devices that are battery-powered do not act as repeaters. It is contemplated that the categorization of mesh network devices into either a AC-powered category or a battery-powered category may be changed to a repeater category and a non-repeater category. Other categorizations of devices are contemplated. In addition, the bridge 110 may be categorized as a AC-powered mesh network device.

The installation and/or configuration modules for devices in the WIFI category may be presented before or after the mesh network modules. The order of installation and/or configuration for the WIFI devices may be similar to the mesh network devices in which the order is generally determined based on the communication behavior or pattern of each particular device. Furthermore, the present application may be used with automation devices 106 other than those discussed herein.

Before the automation devices 106 are installed, the setup logic 306 may also be configured to check whether the bridge 110 has the latest firmware. If the bridge 110 does not have the latest firmware, the server 114 may transmit the latest firmware to the bridge 110.

The processing subsystem 300 may include a module section 310 for presenting and processing modules 312. Generally, there is a module 312 for each of the compatible devices 106 shown on the enrollment cart page of the new account setup and/or device installation process. The modular design may allow for flexibility when one or more new compatible devices 106 are added into the system 100. Each page of the module 312 (e.g., each module may have three pages: Getting Started, Device Enrollment, and Congratulations) provides instructions that walk the customer through how to accomplish each task required. The modules 312 may also have built-in videos on various topics, including device installation, device enrollment, troubleshooting, etc. Additionally, the modules 312 may also provide other resources to the customer, such as helpful tips, troubleshooting charts, installation instructions, resources 314, error messages 320, and tooltips 328, etc. Generally, each module 312 provides the customer with all the information needed to successfully install and enroll their compatible device 106. While a customer is in a module 312, informational error messages 320 may be displayed so that a customer knows what steps to take if there are any problems enrolling a device 106. Furthermore, the new account setup and/or device installation process may keep track of what page or module 312 a customer is at in the process, which allows customer support to know how to best help the customer if the customer calls regarding a technical issue.

The processing subsystem 300 may include a resource section 314 that provides resources 316 that are built into the various modules 312. For example, resources 316 may include built-in videos on various topics, including device installation, device enrollment, troubleshooting, etc. Additionally, the modules 312 also provide other resources 316 to the customer, such as helpful tips, troubleshooting charts, installation instructions, etc. Each module 312 generally is designed in such a way that the customer generally would not need to utilize any other information, except for what is provided on a screen, to successfully install and enroll their compatible device 106.

The processing subsystem 300 may also include an error message section 318, which provides error messages 320 to a customer. For example, if a customer enters a bridge MAC ID or MAC address that is already in use on another account they will receive an error message 320 explaining that the MAC ID or MAC address is in use and that they need to call customer support to fix the issue. The error messages 320 generally include not only the particular error, but also a description of how to fix or rectify the error. In one form, detailed information obtained from the server 114 during the enrollment process may be included in the error message 320 to help the customer fix the error.

The processing subsystem 300 may also include a tracking section 322, which records, e.g., in a database at the server 114, every time a customer has successfully completed a page in the new account setup and/or device installation process. This generally allows customer support to be able to know what page a customer is experiencing difficulty with when the customer calls for technical assistance. The tracking section 322 may provide data 324 related to completed pages and about where customers stop the account setup and/or device installation process. The data 324 may help the provider make improvements to the process in the future and may allow the provider to proactively reach out to customers that are experiencing difficulty on a specific page by offering technical assistance.

The processing subsystem 300 may include a help section 326, which displays tooltips 328 (e.g., shown by a help icon). The tooltips 328 may be displayed throughout the new account setup and/or device installation processes 400, 500, 600, 700 to proactively address potential questions a customer might have during any aspect of the process.

The processing subsystem 300 may also include an input/output section 330 to transfer data or information to and from the computer 200 to an external device 210.

The schematic flow diagrams in FIGS. 3A and 4-46, and the related descriptions which follow, are illustrative embodiments of techniques for setting up a new account and/or installing in a network 108, one or more devices 106. Operations illustrated are understood to be exemplary only, and operations may be combined or divided, and added or removed, as well as re-ordered in whole or in part, unless explicitly stated to the contrary. The techniques 350, 400, 500, 600, and 700 may be implemented by one or more computers executing one or more computer programs stored on a computer readable medium. The computer program comprises instructions or operating logic causing the computer to execute one or more of the operations of the techniques 400, 500, 600, and 700. In certain embodiments, the computer program may be comprised of sections, such as those described herein.

FIG. 3A illustrates an exemplary technique 350 implemented by the server 114 for setting up an account and/or installing and configuring one or more devices 106. Technique 350 begins at operation 352 in which the enrollment cart section 302 of the server 114 determines whether an account for the customer already exists. If the customer does not have an account, technique 350 proceeds from operation 352 to operation 354 in which the enrollment cart section 302 allows the user to create a new account. If the customer already has an account, technique 350 proceeds from operation 352 to operation 356.

At operation 356, the enrollment section 302 of the server 114 allows the customer to select the various automation devices 106 to install and/or configure in the building 104. Technique 350 then proceeds from operation 356 to operation 358. At operation 358, the setup logic section 306 determines whether any of the automation devices 106 selected are to be installed in a mesh network. If none of the devices 106 selected are for a mesh network, technique 350 proceeds from operation 358 to operation 360 in which the customer is presented with various modules 312 for installing and configuring devices 106, such as WIFI devices.

If the customer selected devices 106 to be installed and configured in a mesh network, the server 114 generally will begin with those devices and proceed to operation 362. However, it is contemplated that the WIFI devices (e.g., cameras, certain thermostats, and the like) may be installed and/or configured first. At operation 362, the setup logic section 306 determines the order of installation for the selected devices 106. Generally, the AC-powered devices (e.g., light control modules, appliance modules, thermostats, and the like) are installed and/or configured before the battery-operated devices (e.g., sensors, locks, and/or the like).

Technique 350 then proceeds from operation 362 to operation 364. At operation 364, the setup logic section 306 will determine whether the bridge 110 has the latest firmware. If the bridge 110 does not have the latest firmware, the server 114 updates the firmware in the bridge 110. Then, the customer is presented with the module 312 for installing and configuring a bridge 110. After the customer has installed the bridge 110, the technique 350 proceeds from operation 364 to operation 366.

At operation 366, module section 310 presents modules 312 for the AC-powered devices selected to be installed and/or configured. The modules 312 guide the customer through the installation and/or configuration process as described above. In addition, the customer may be presented with various resources 316, error messages 320, and/or help tips 326.

After the customer installs all of the AC-powered devices, technique 350 proceeds from operation 366 to operation 368. At operation 368, the module section 310 presents modules 312 for the battery-powered devices selected to be installed and/or configured. The modules 312 guide the customer through the installation and/or configuration process as described above. In addition, the customer may be presented with various resources 316, error messages 320, and/or help tips 326.

After the customer installs all of the battery-powered devices, technique 350 proceeds from operation 368 to operation 370. At operation 370, the module section 310 presents modules 312 for any WIFI-devices selected to be installed and/or configured. The modules 312 guide the customer through the installation and/or configuration process as described above. In addition, the customer may be presented with various resources 316, error messages 320, and/or help tips 326. It is contemplated that the WIFI-devices may be installed and/or configured before the mesh network devices. In addition, it is contemplated that a network other than WIFI may be used.

During the installation and/or configuration process of the devices 106, the tracking section 322 of the server 114 tracks the progress of each device 106 and stores the progress and/or other information in a database as described above.

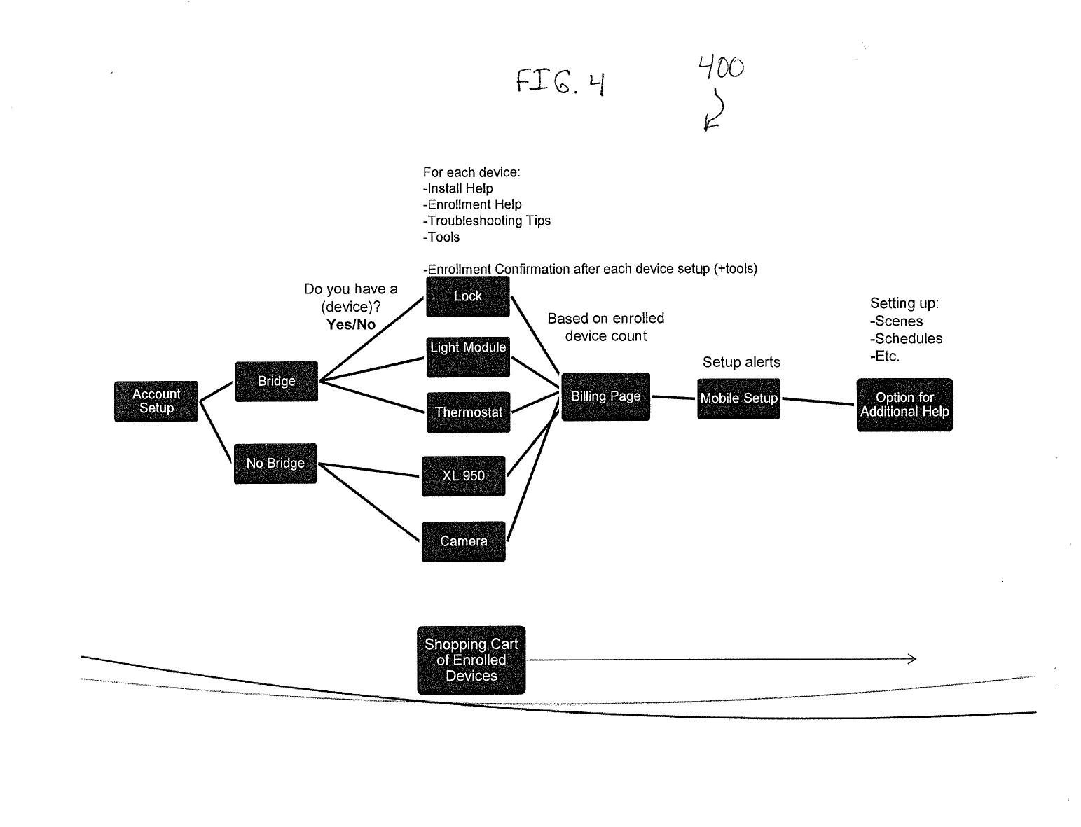

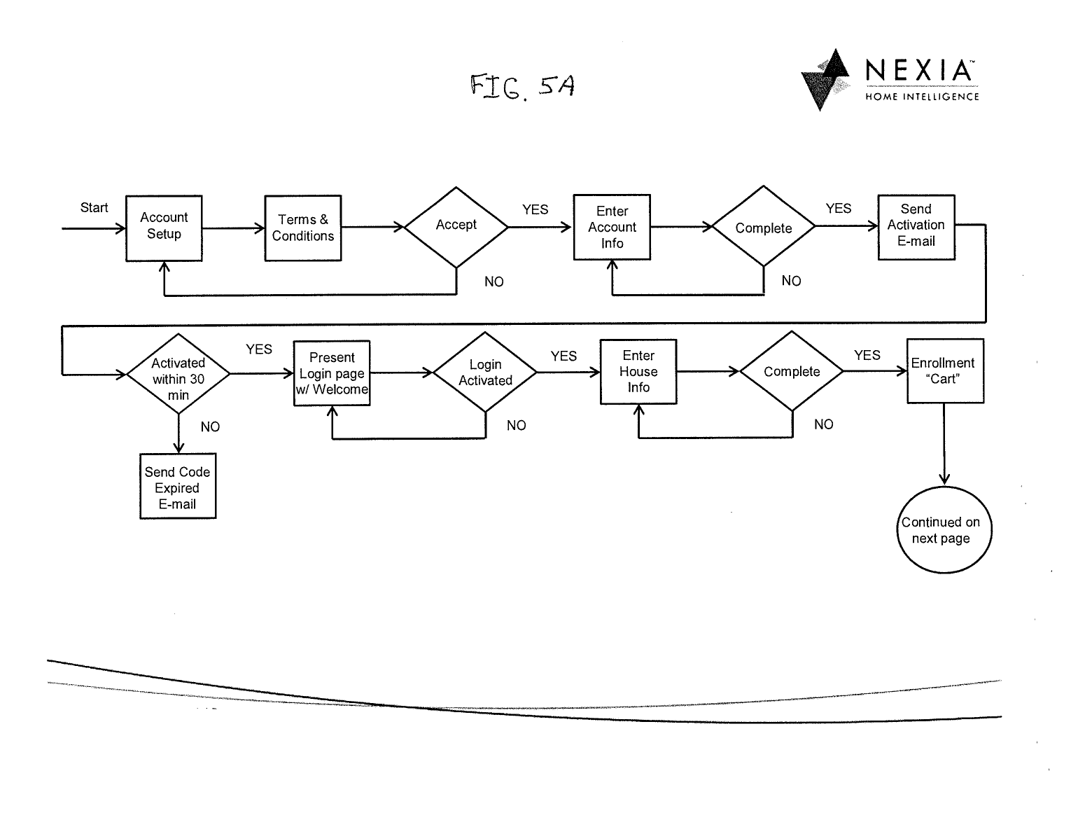

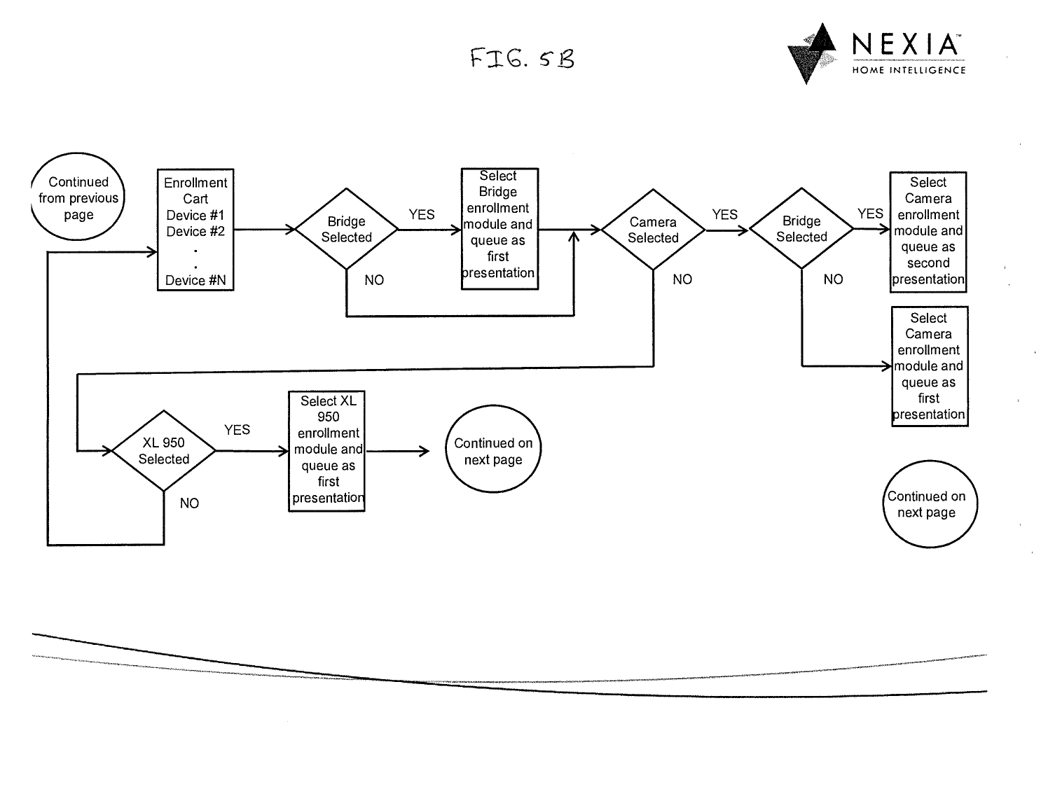

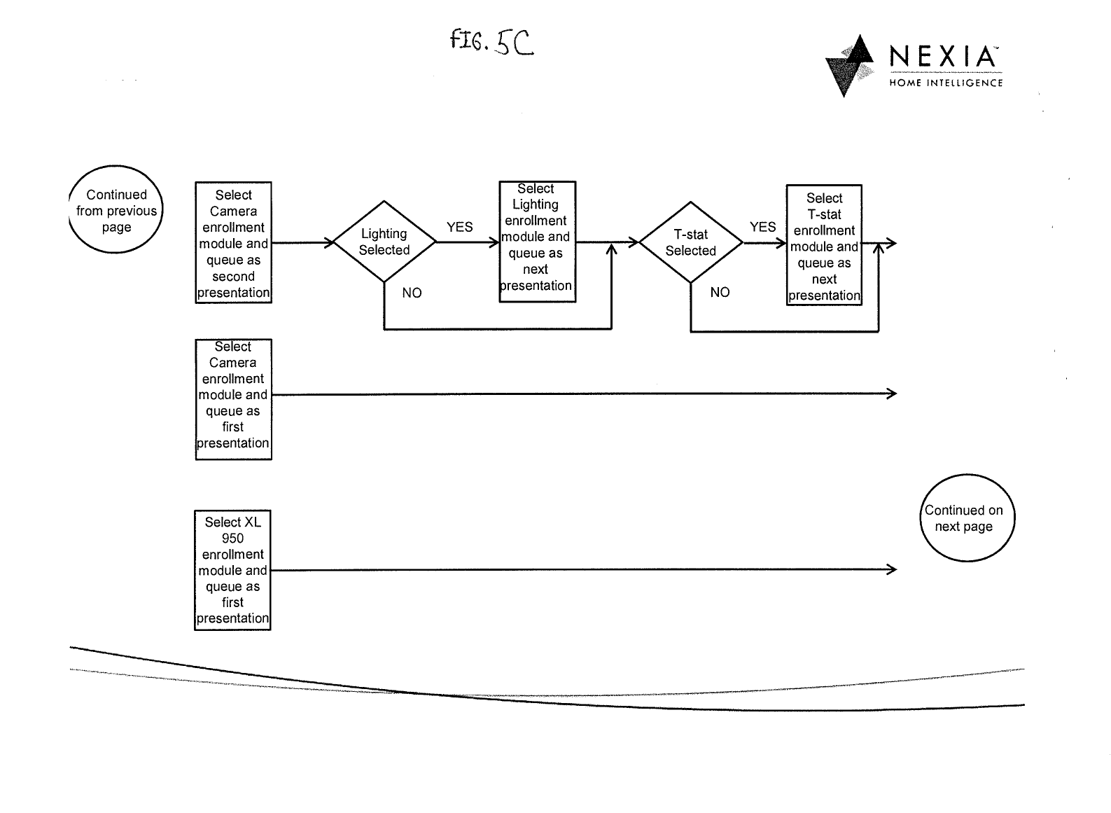

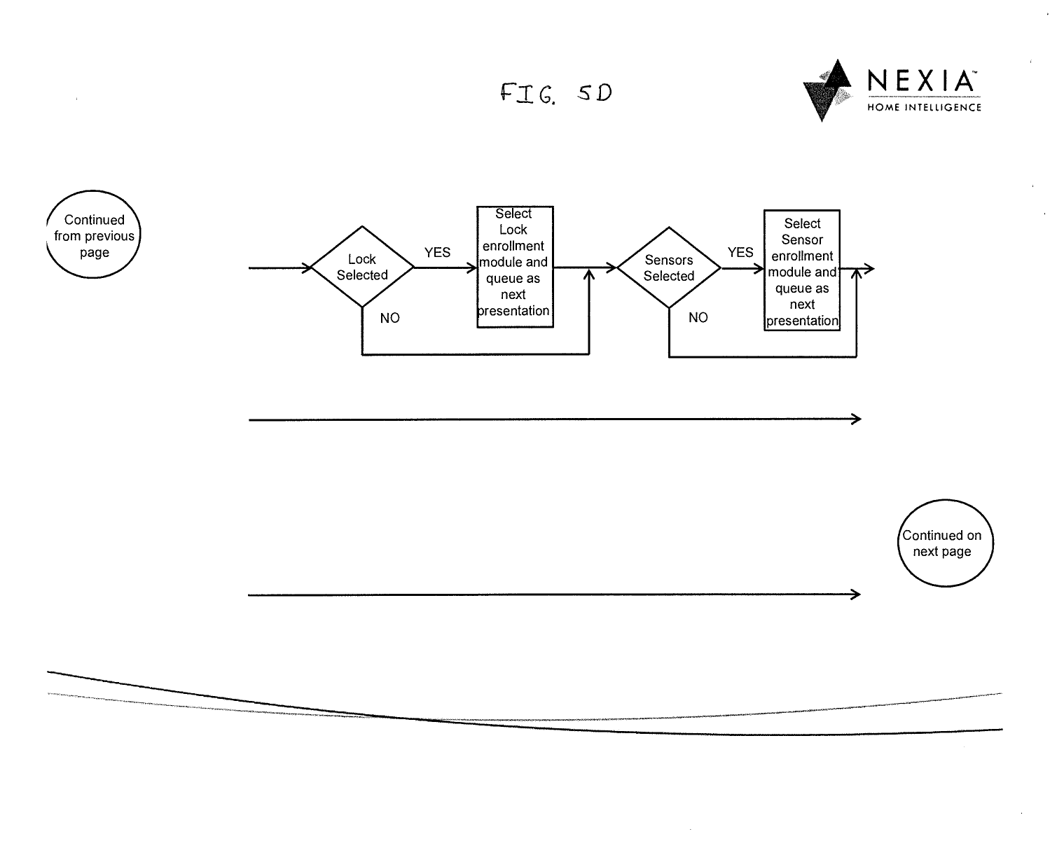

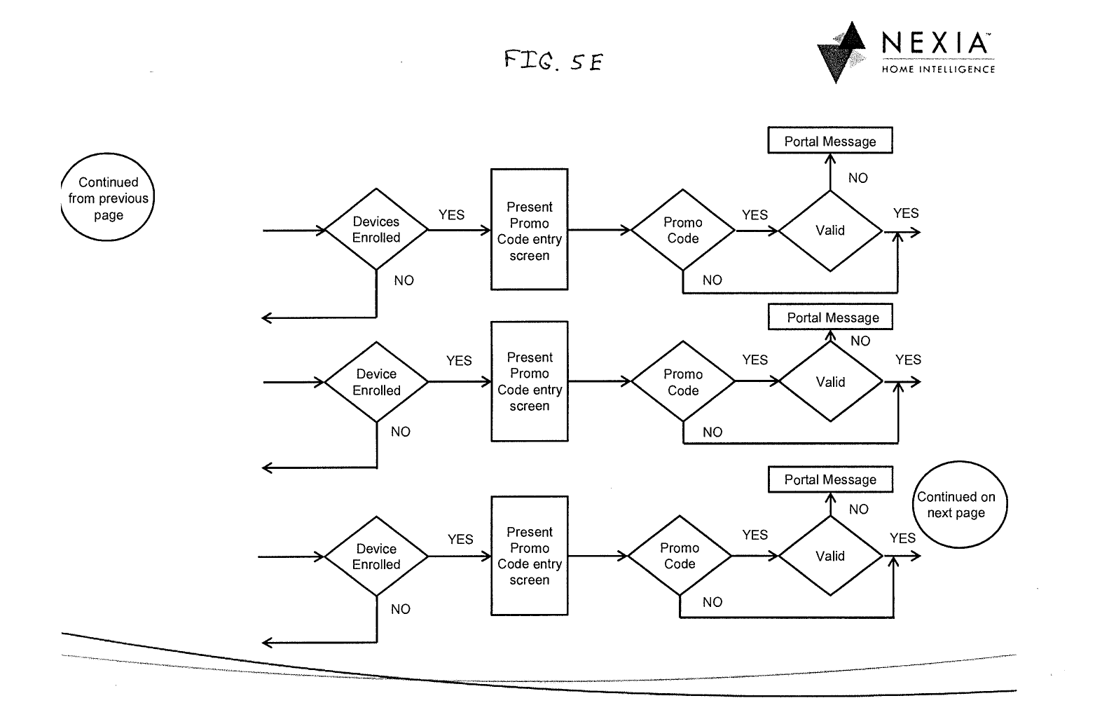

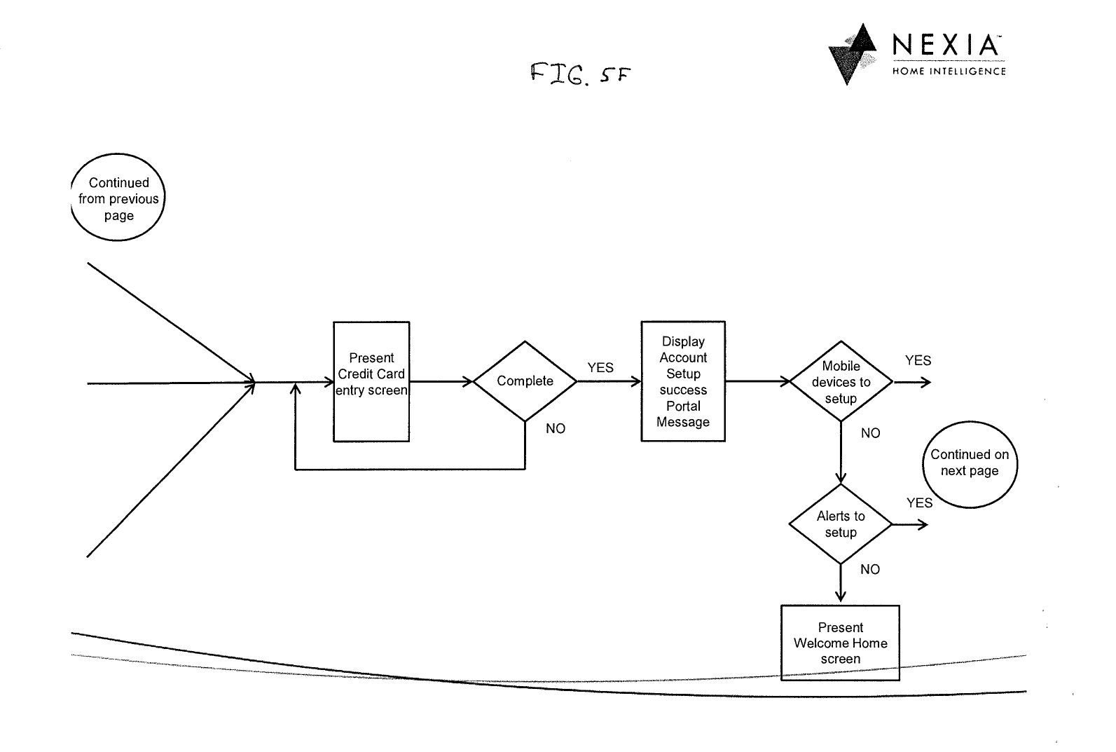

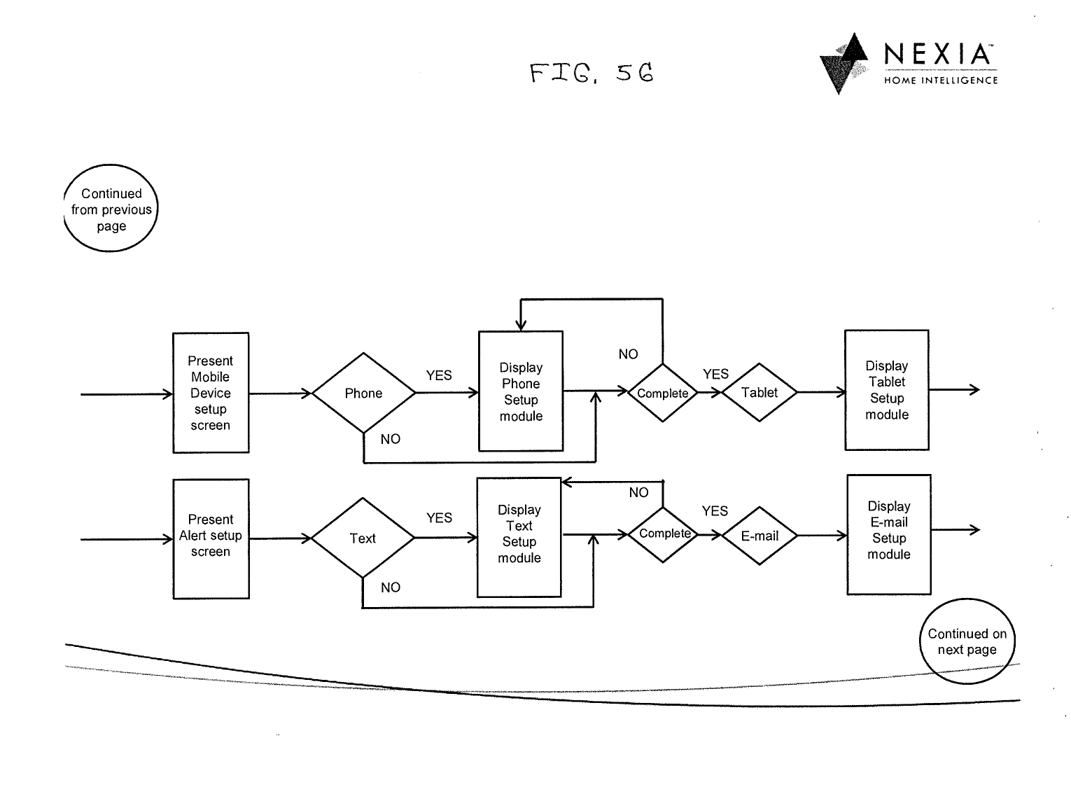

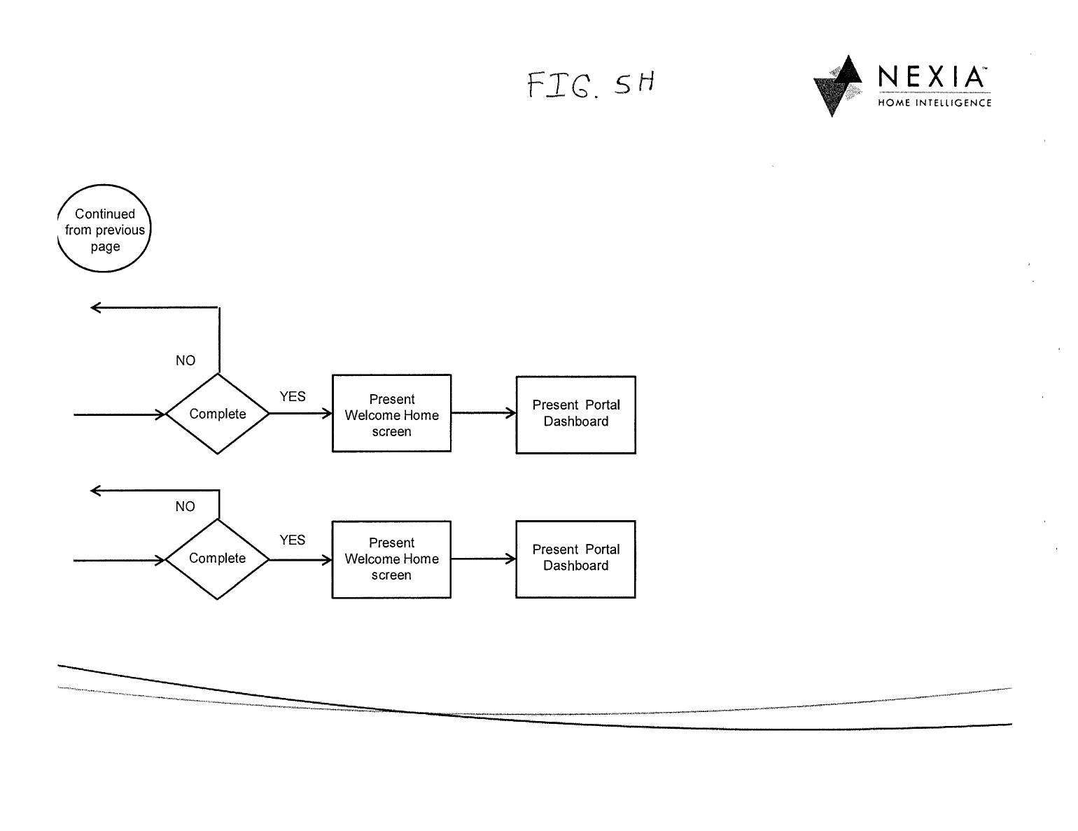

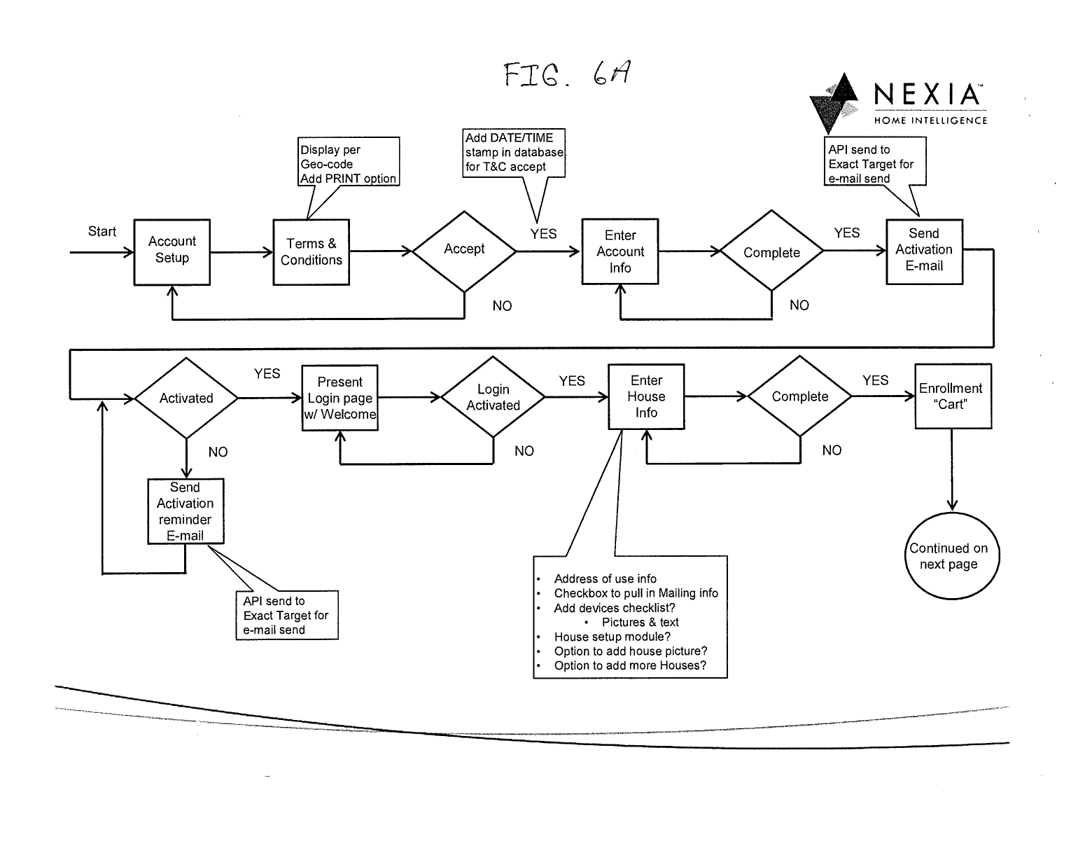

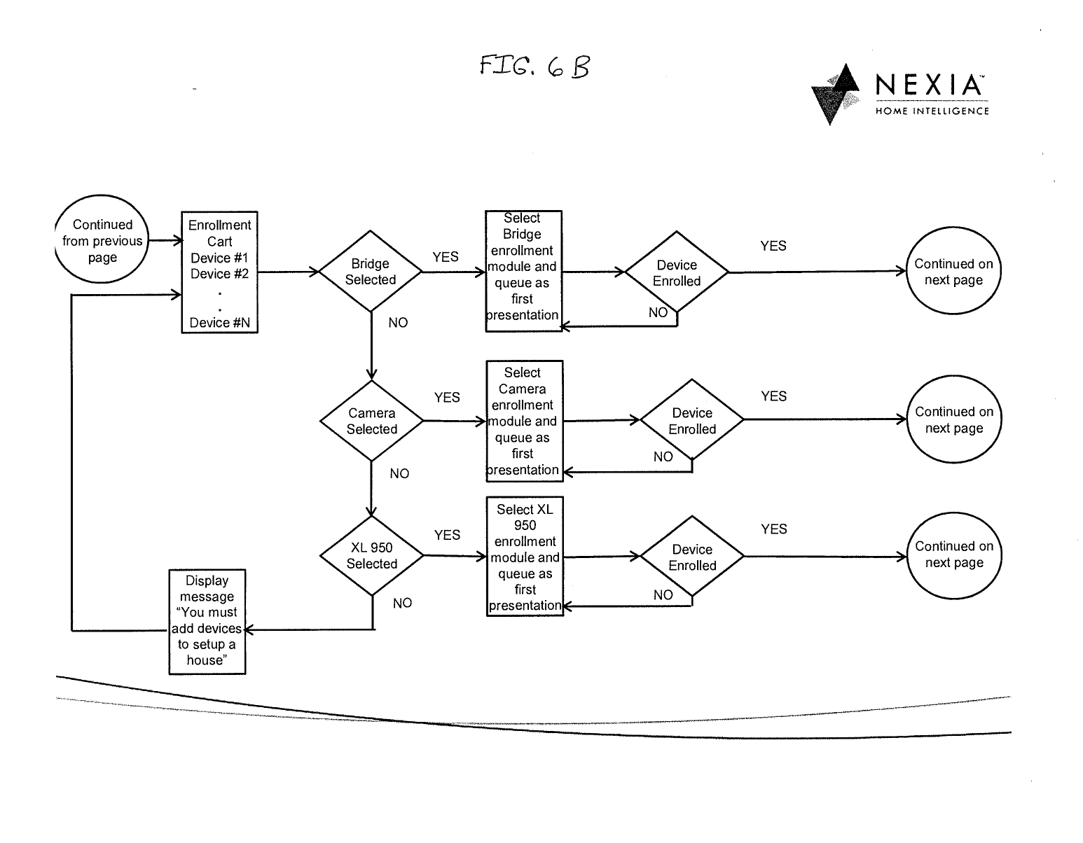

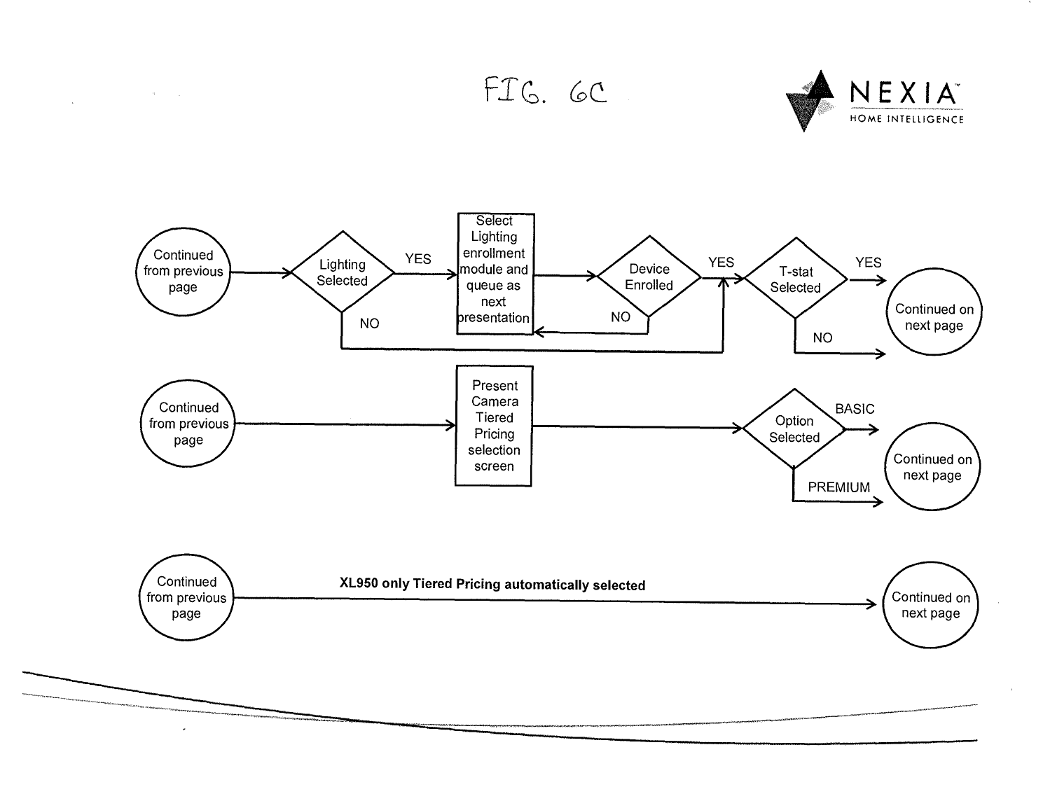

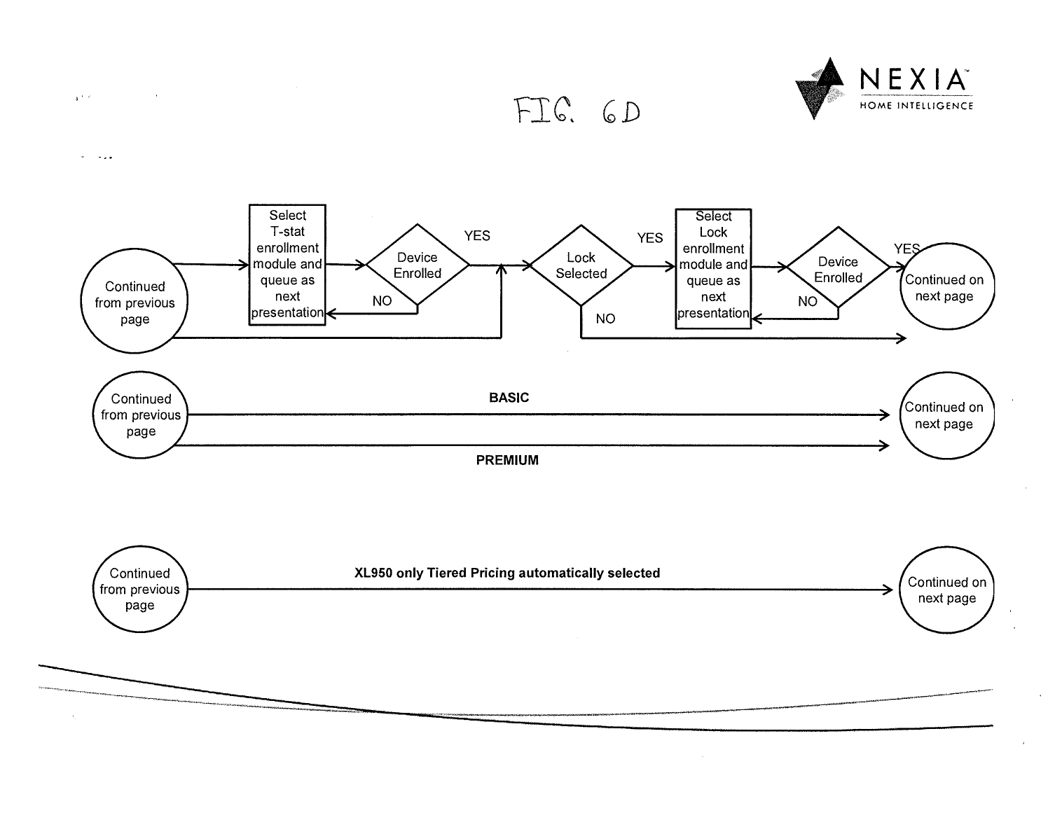

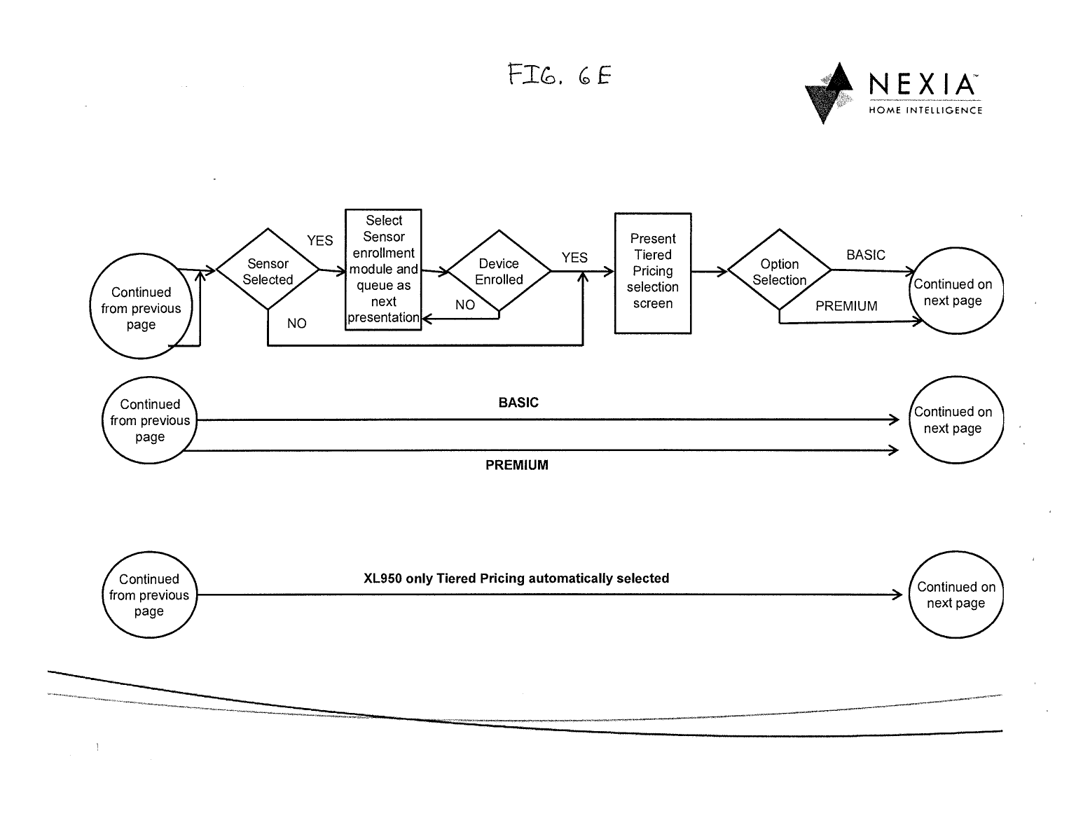

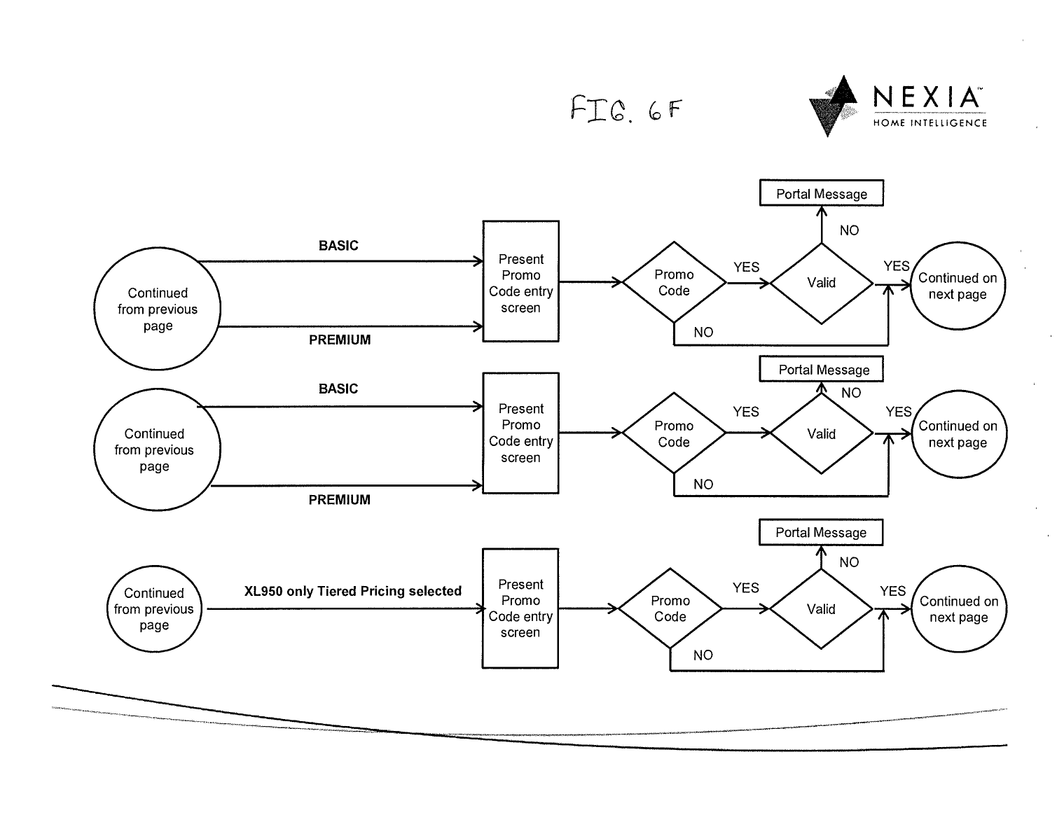

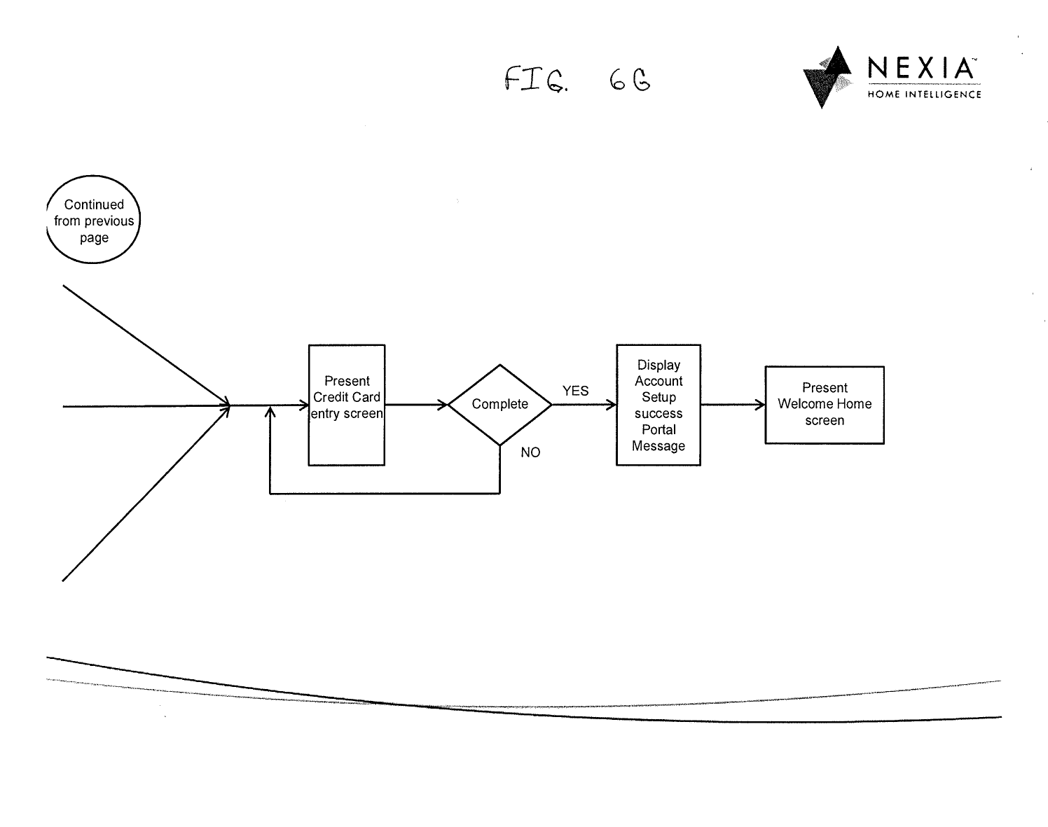

FIG. 4 illustrates a technique 400 for setting up an account and/or installing devices 106 in a network 108. FIGS. 5A-5H illustrate a technique 500 for setting up an account and/or installing devices 106 in a network 108. FIGS. 6A-6G illustrate a technique 600 for setting up an account and/or installing devices 106 in a network 108.

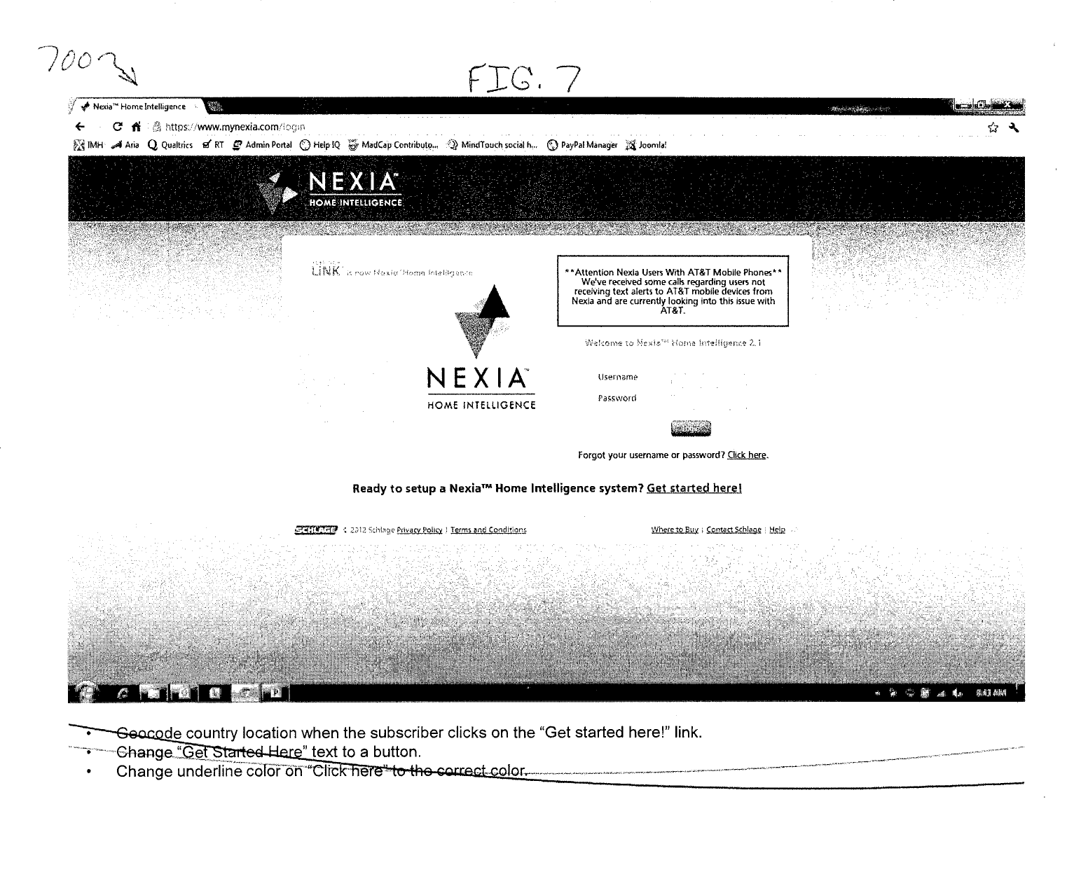

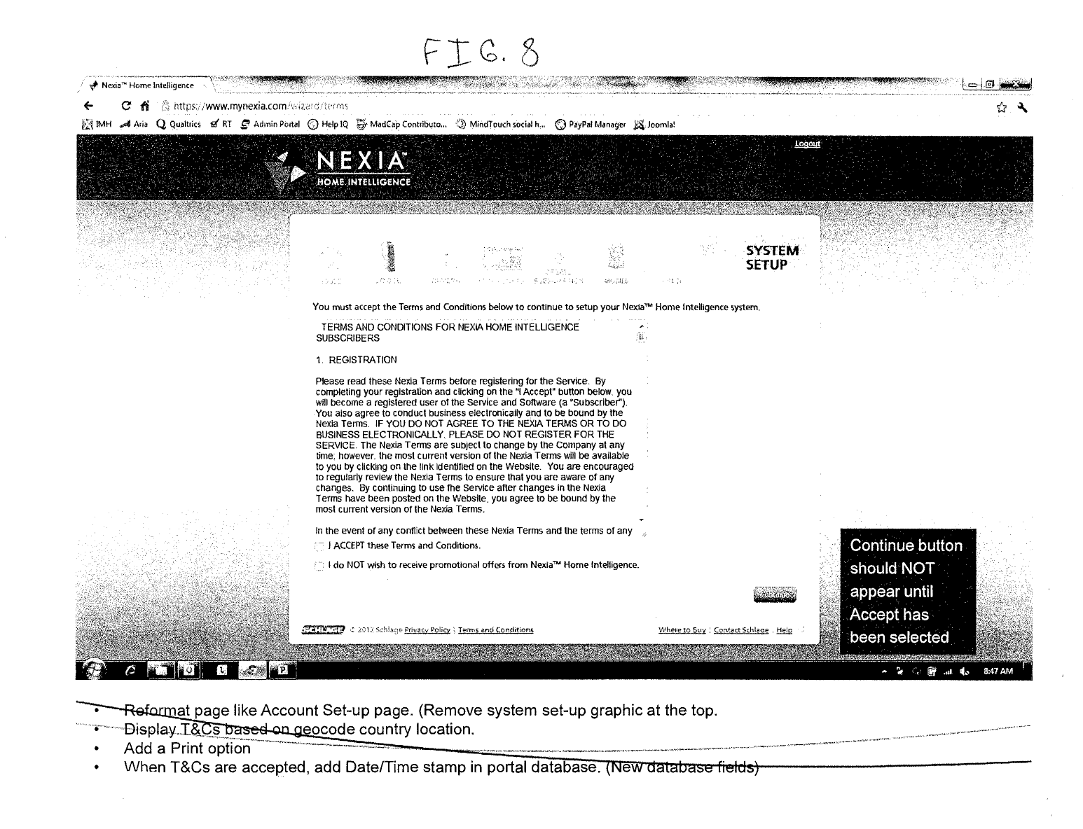

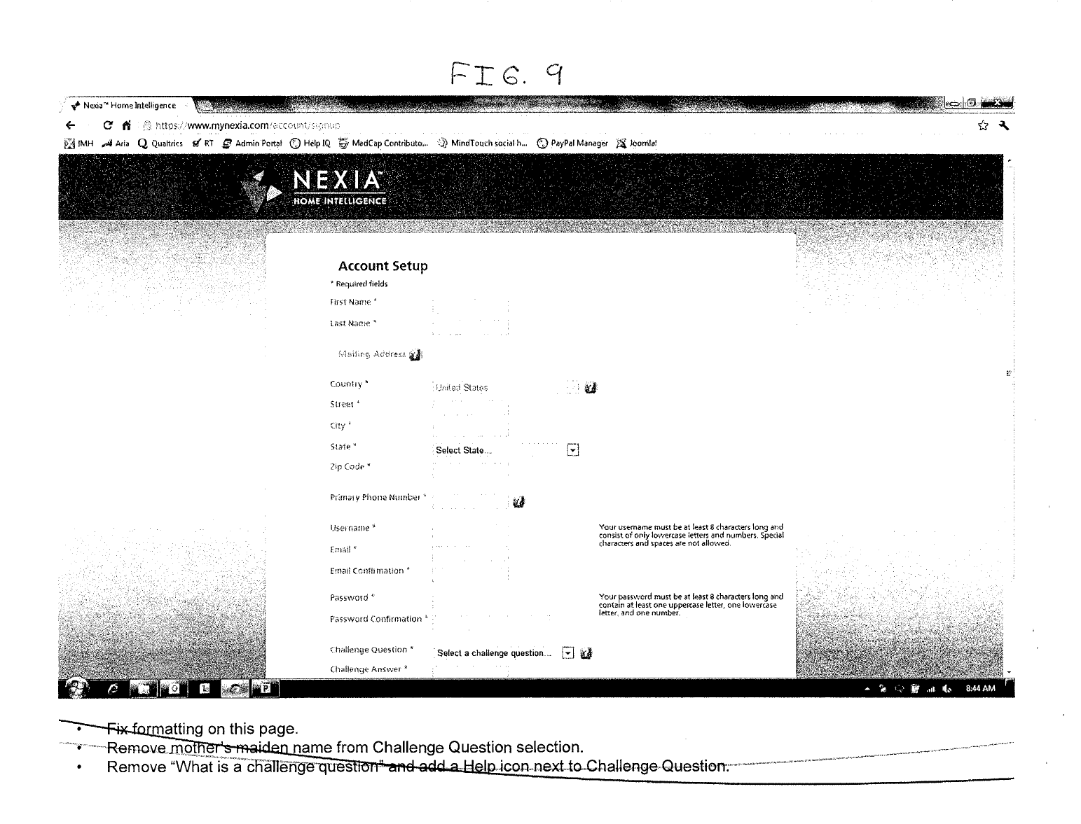

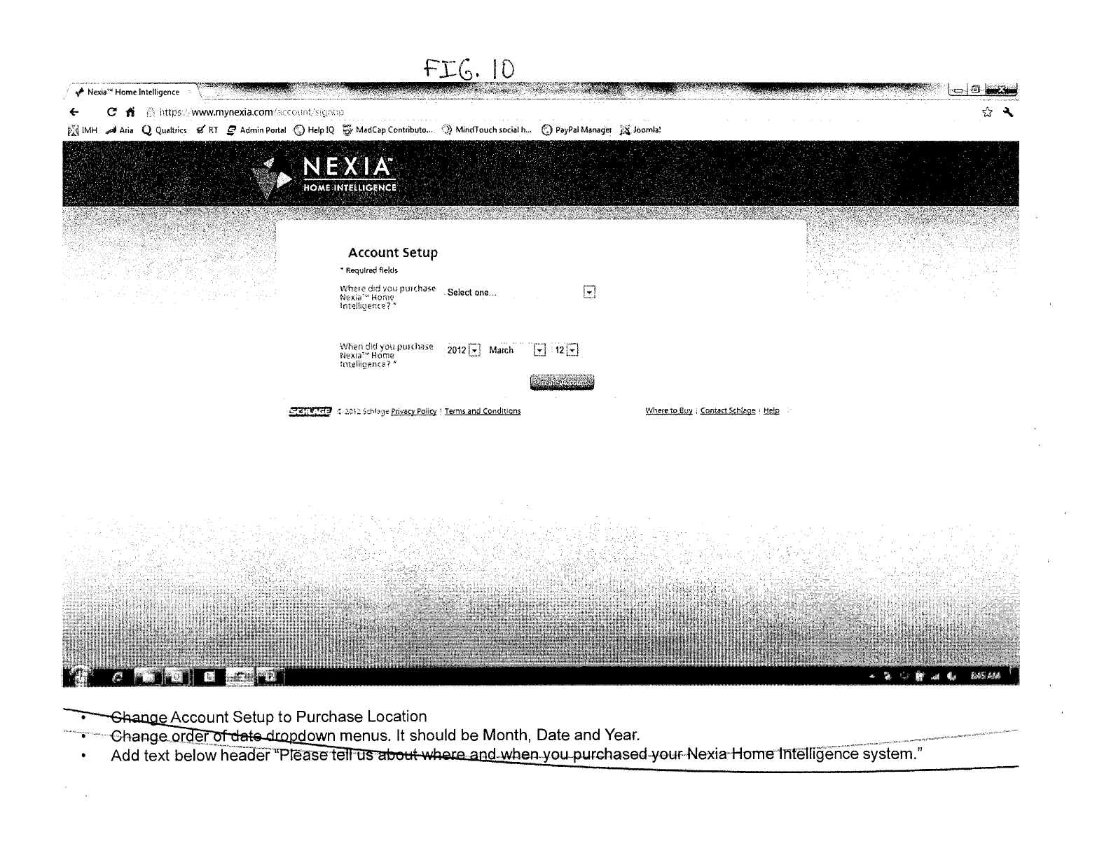

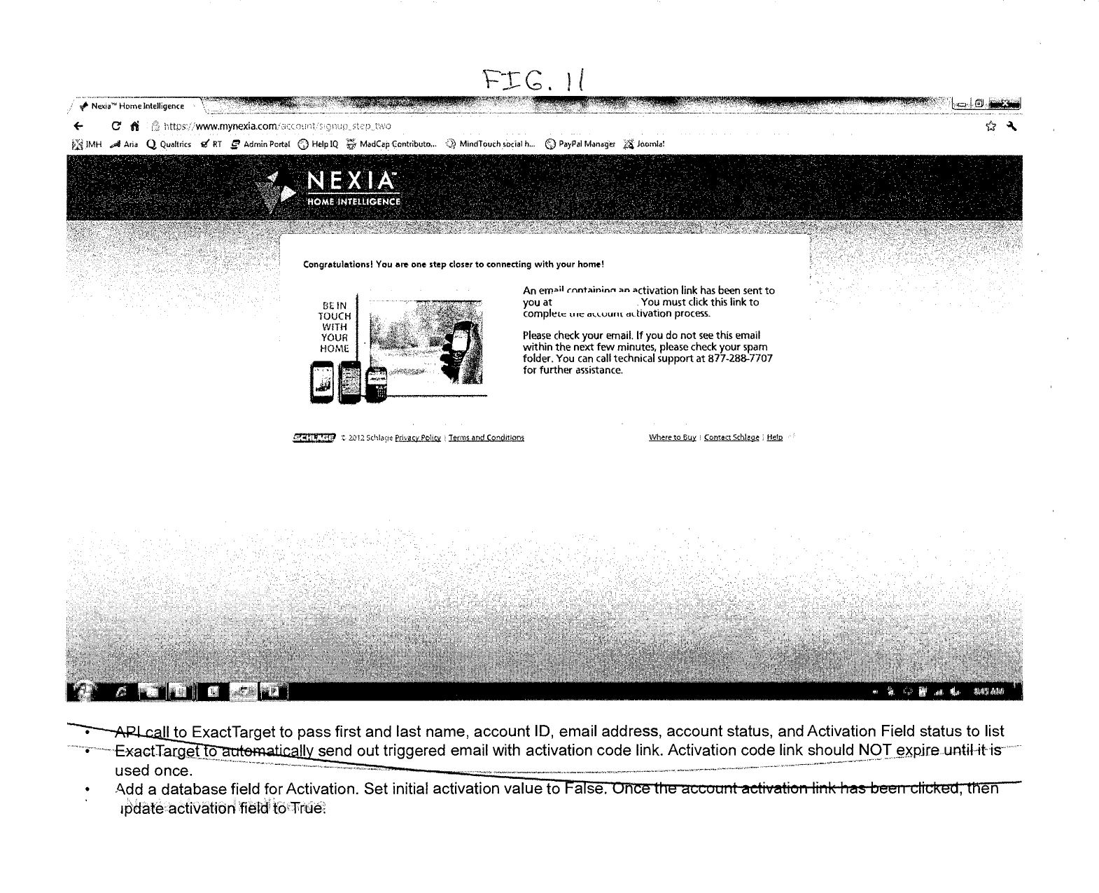

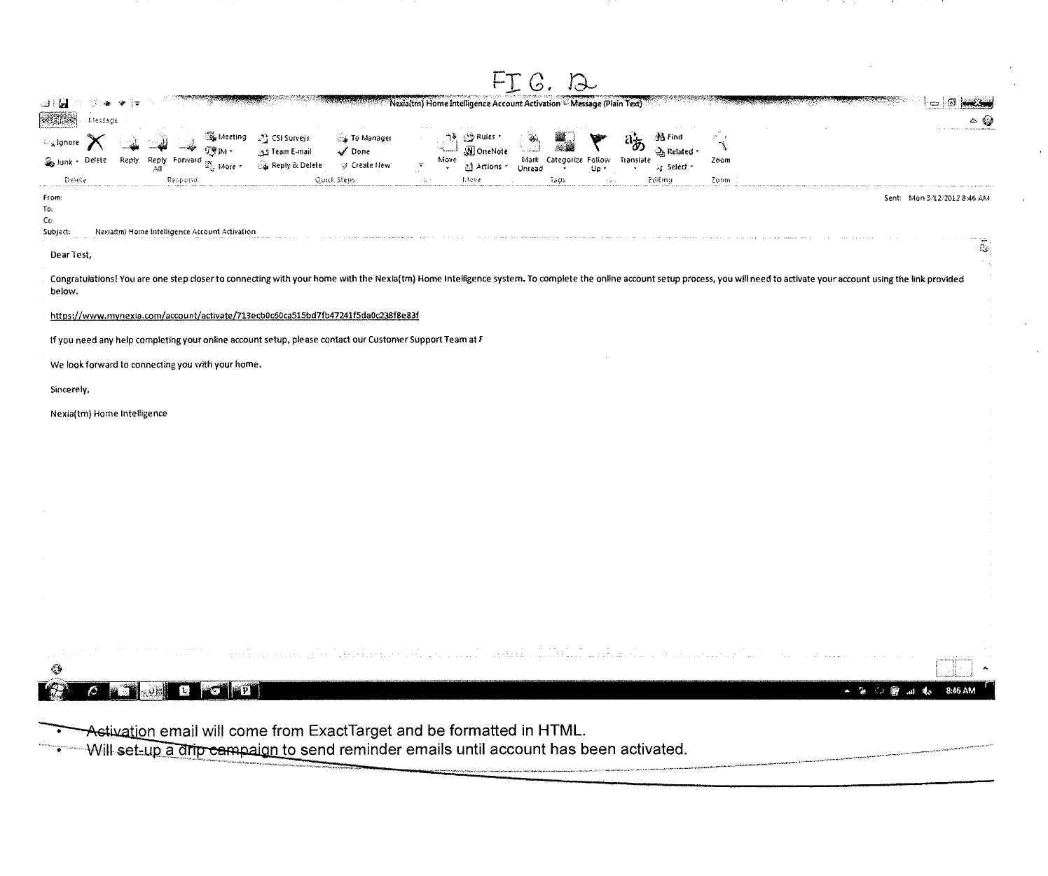

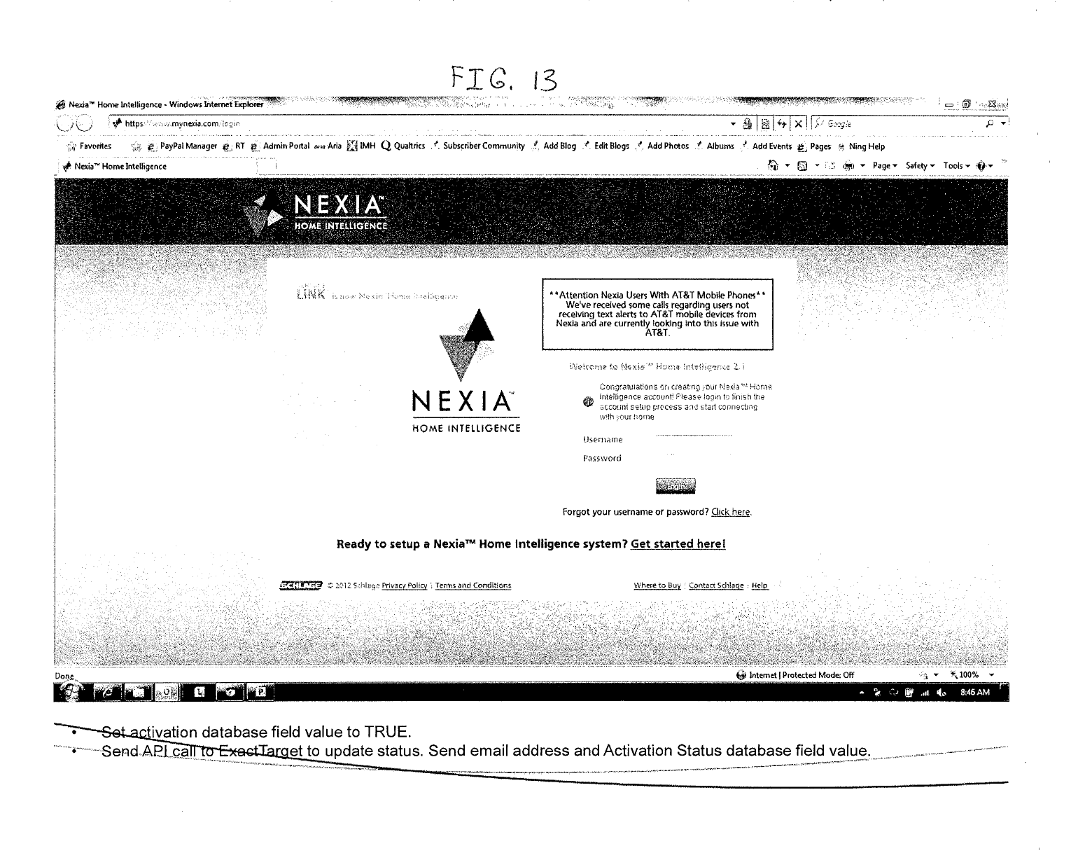

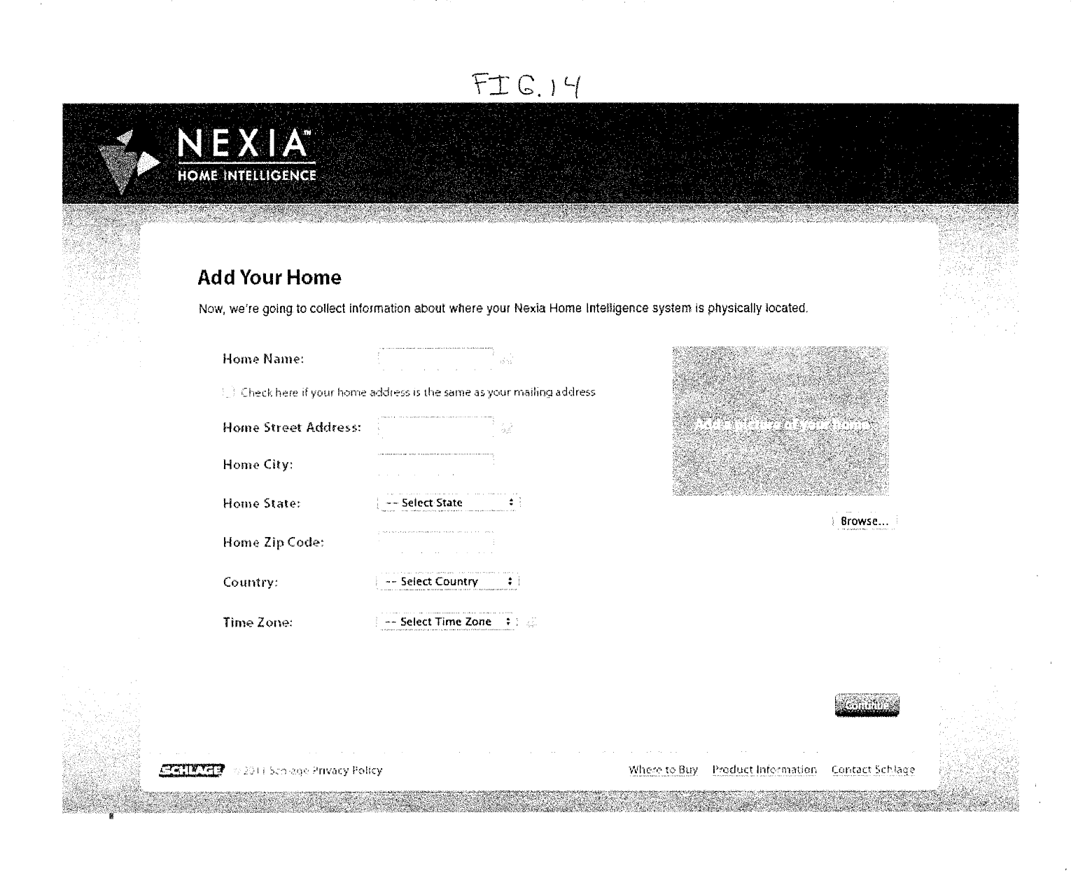

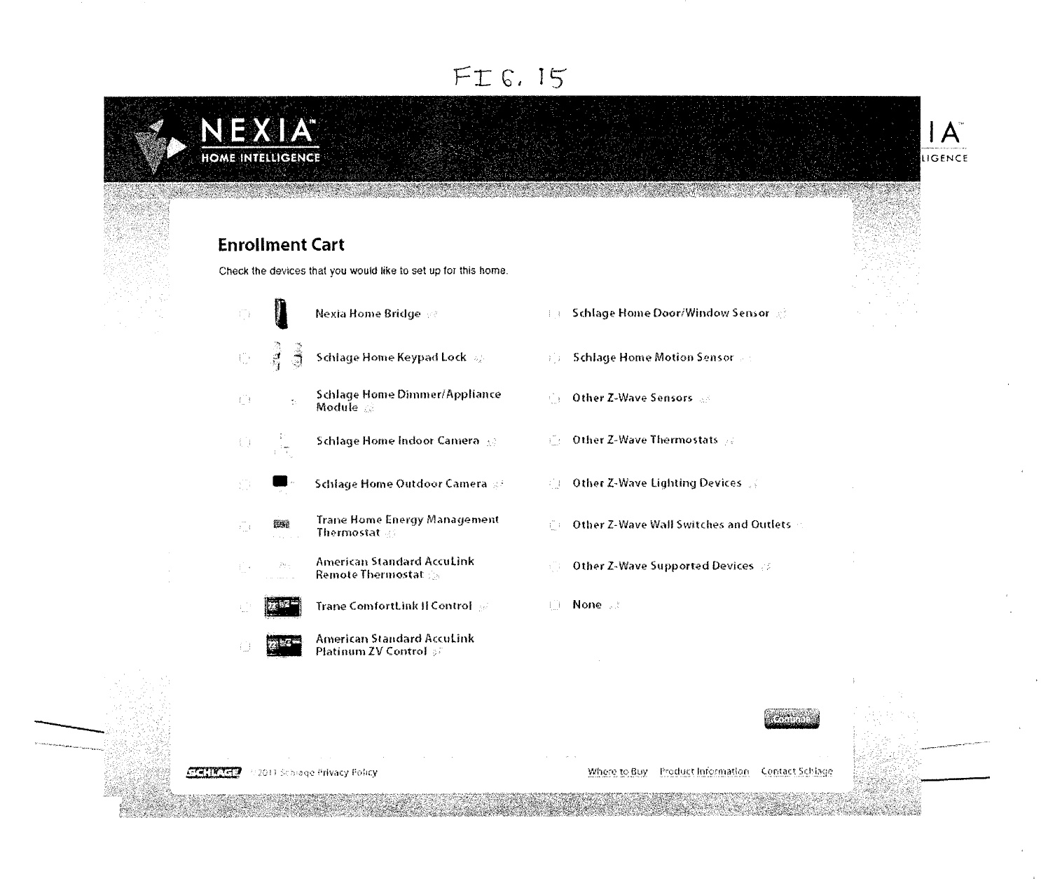

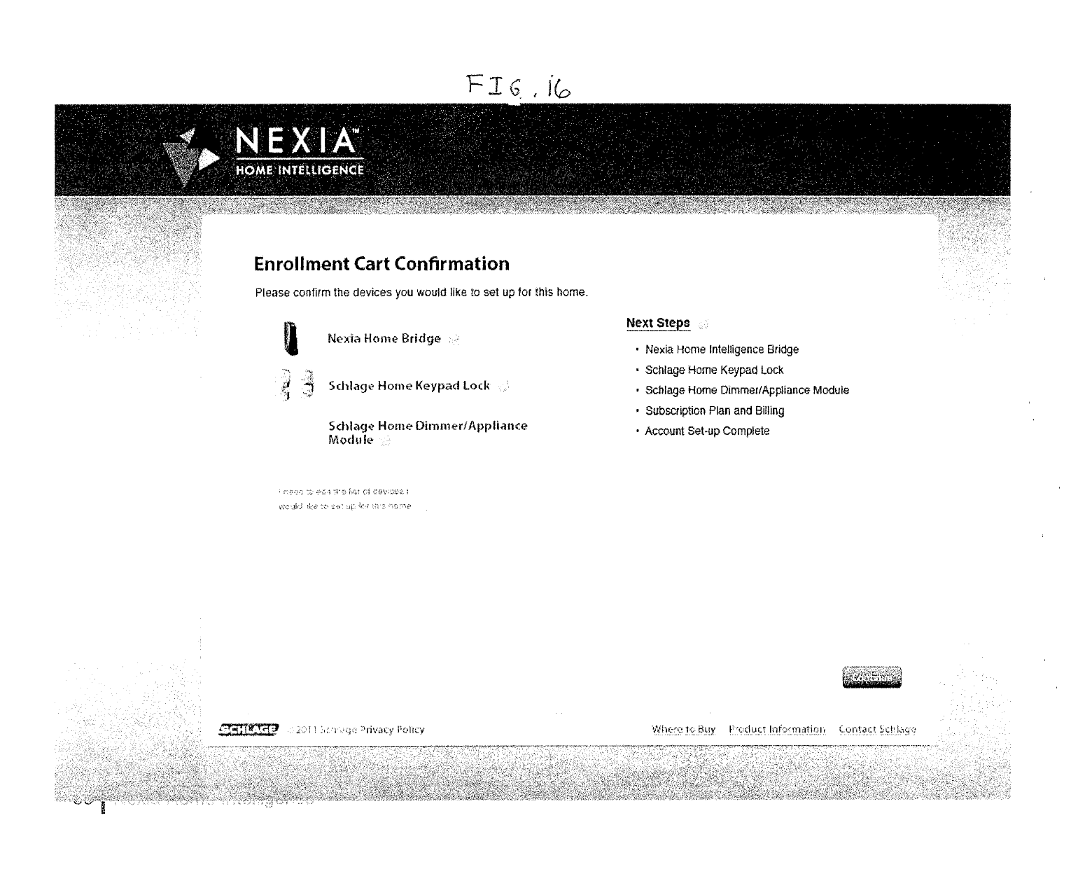

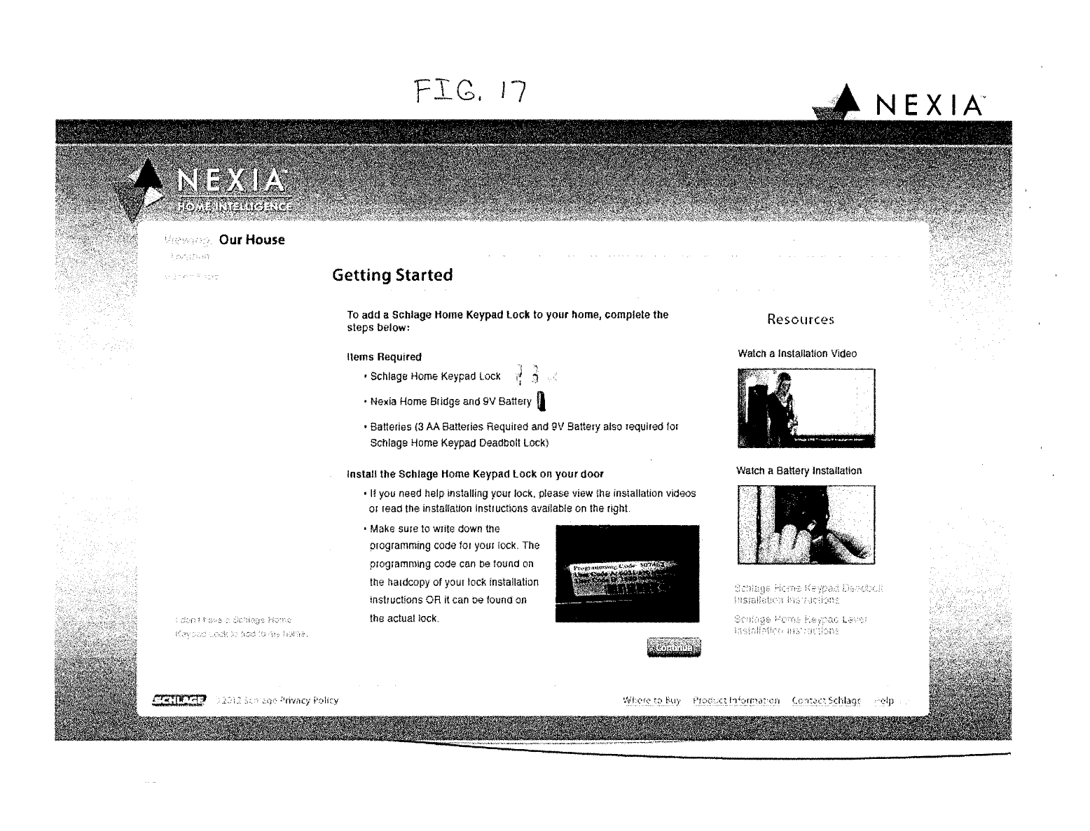

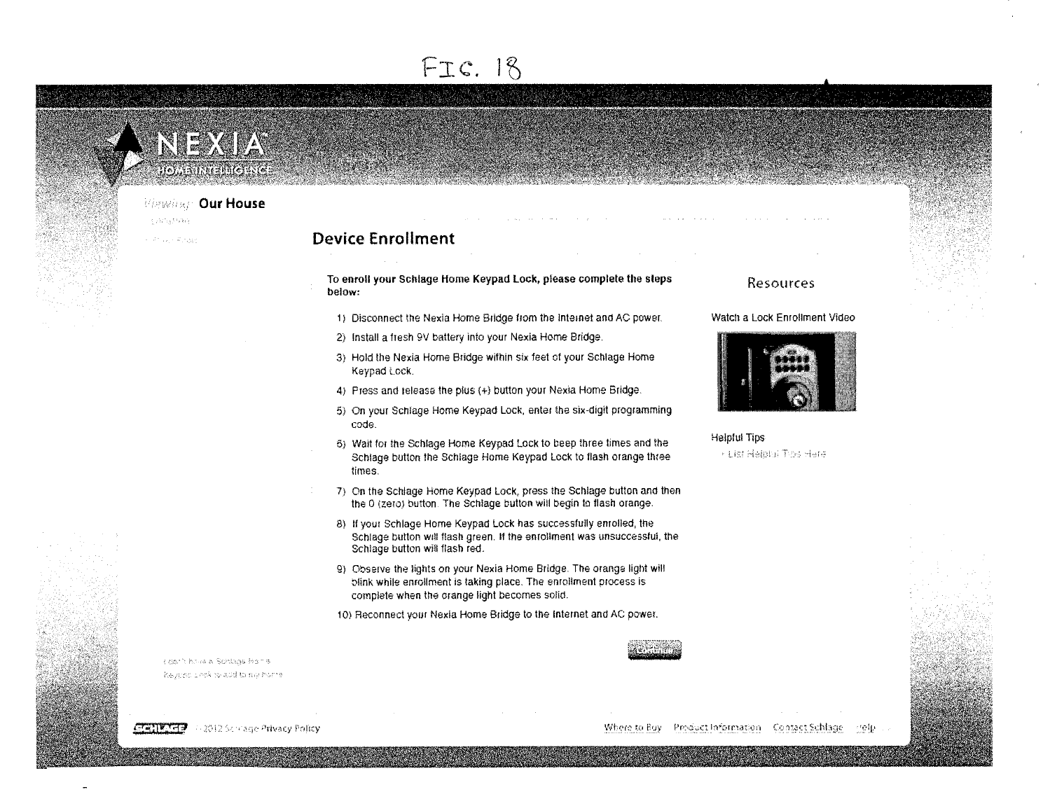

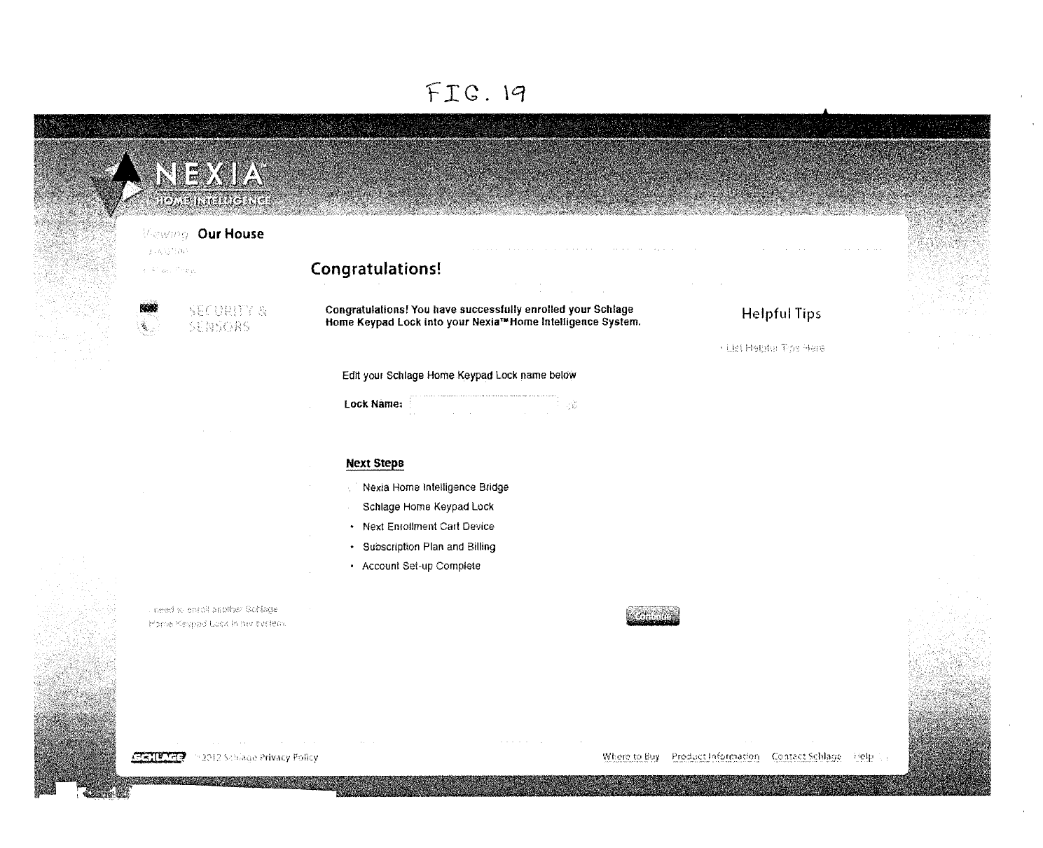

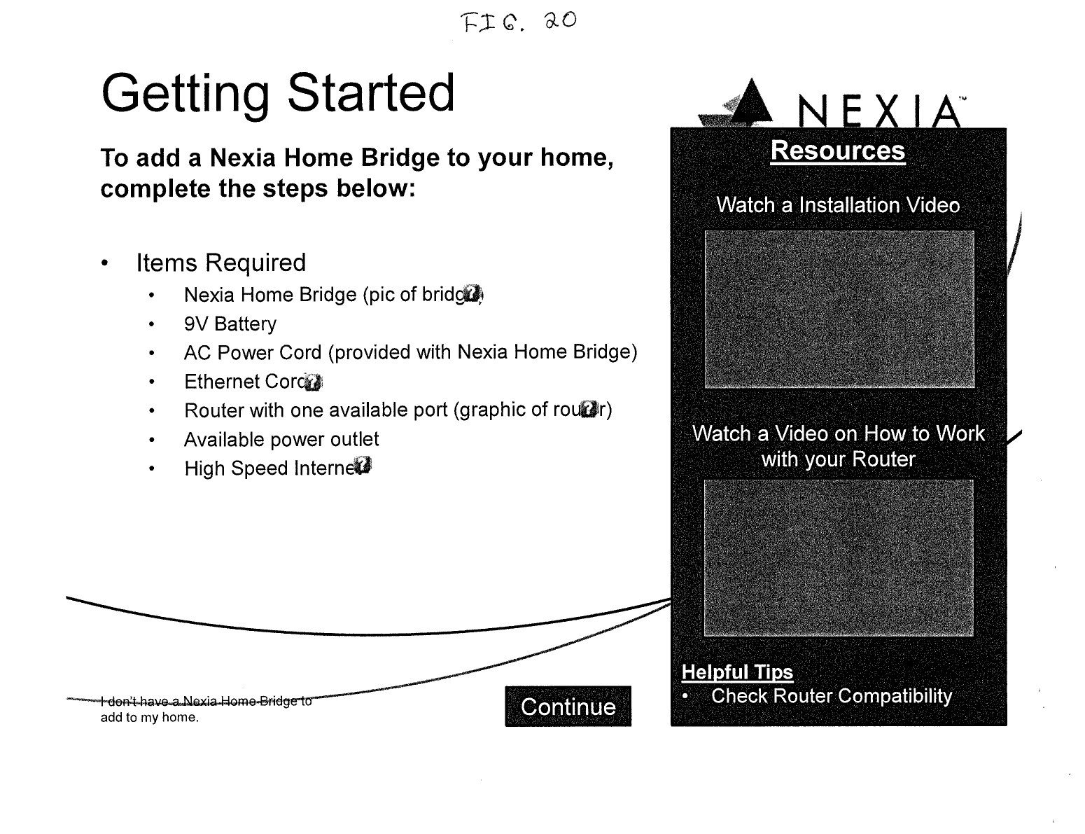

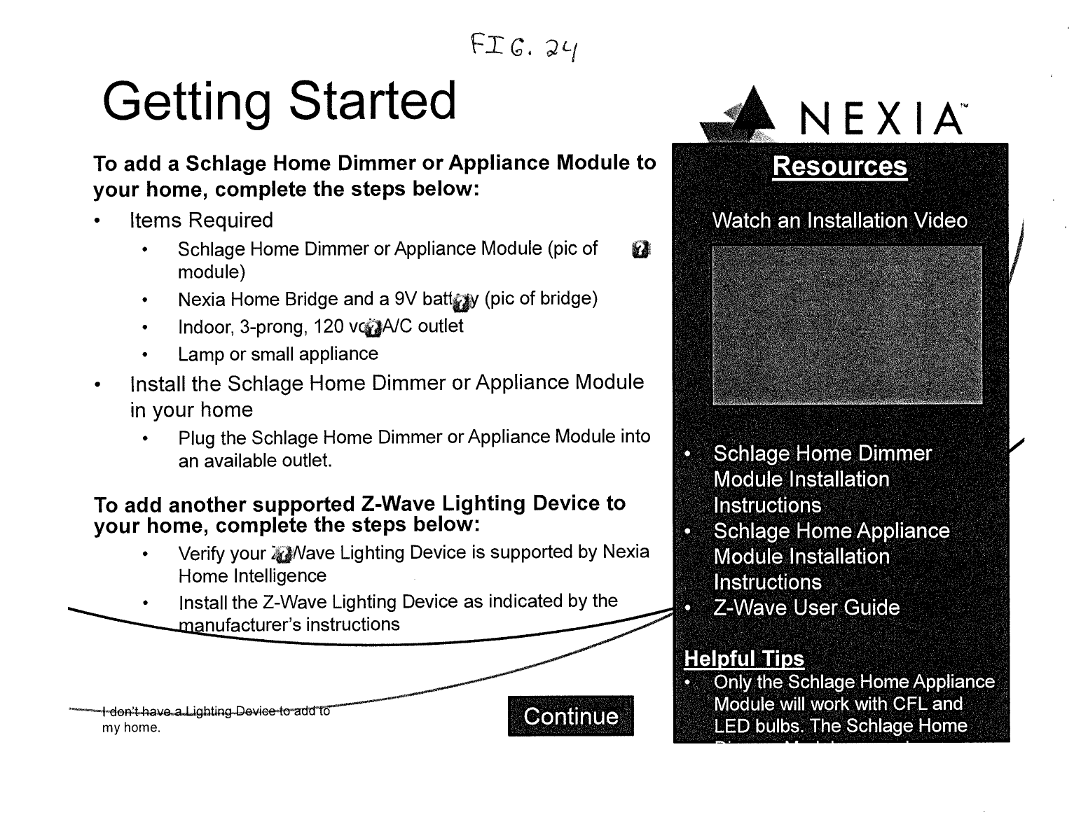

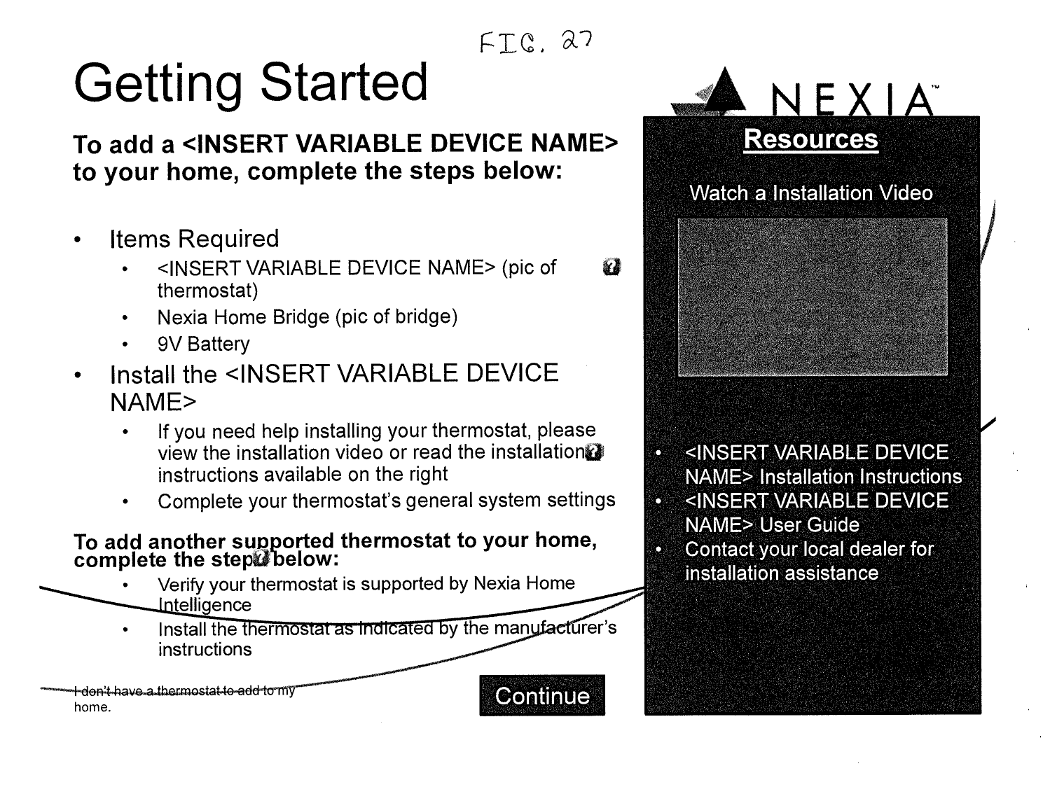

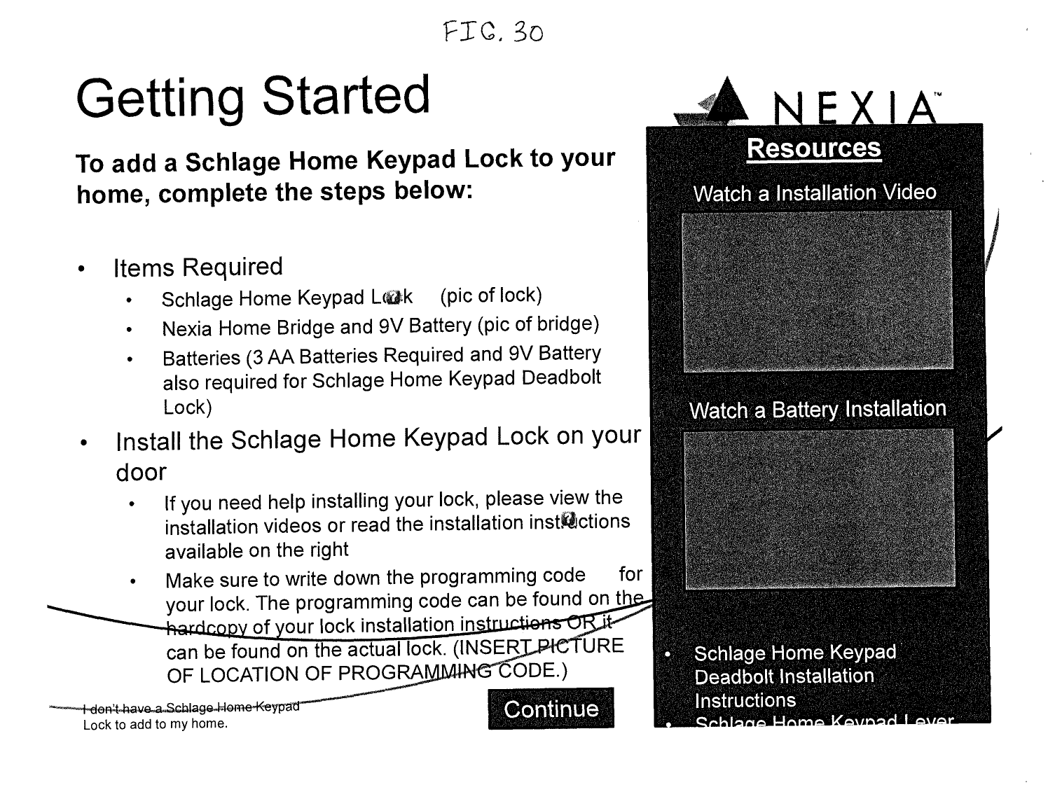

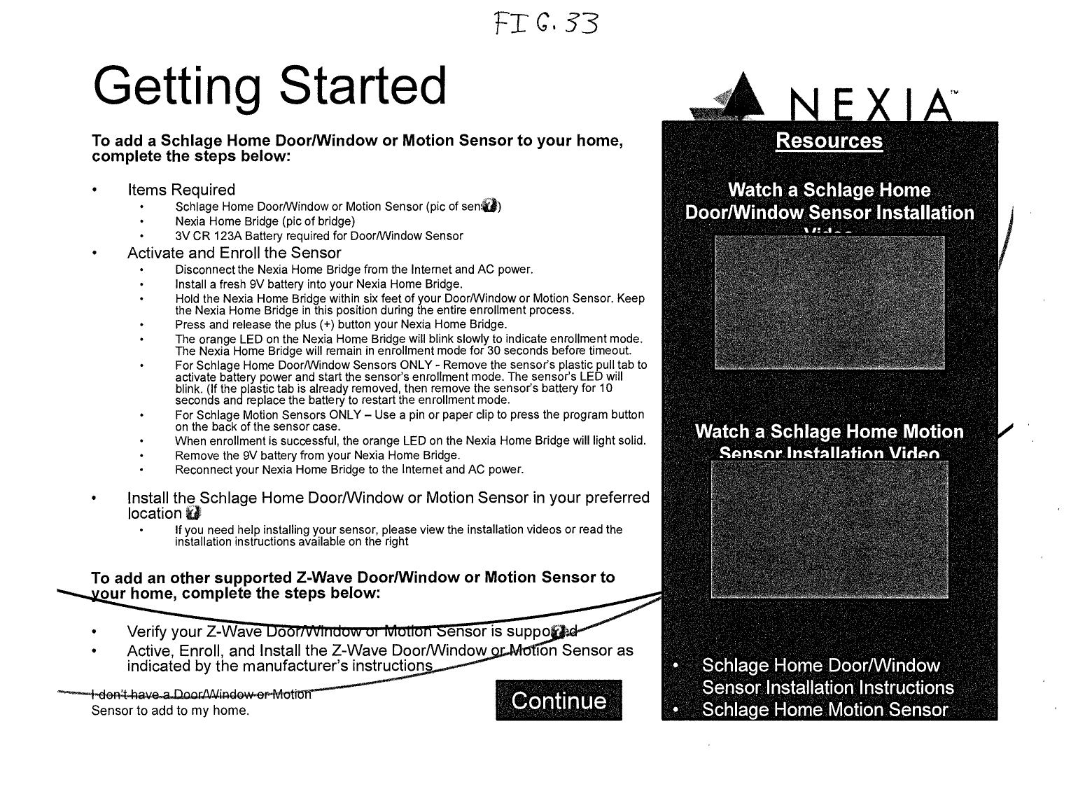

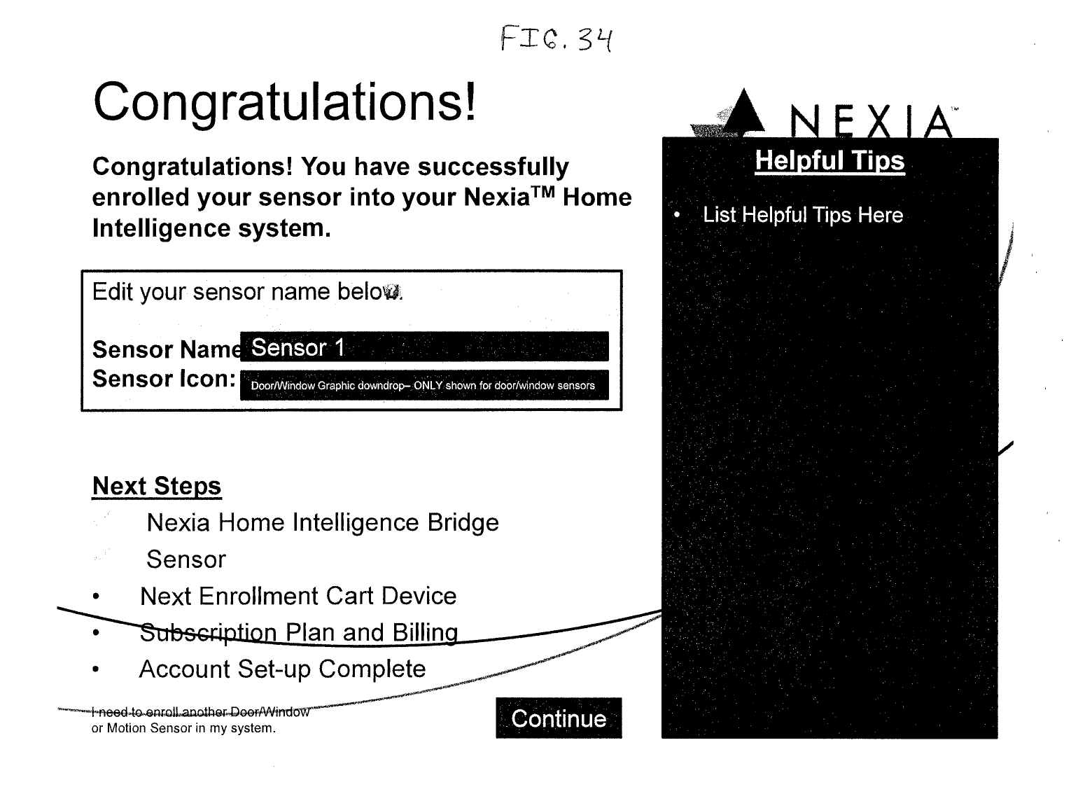

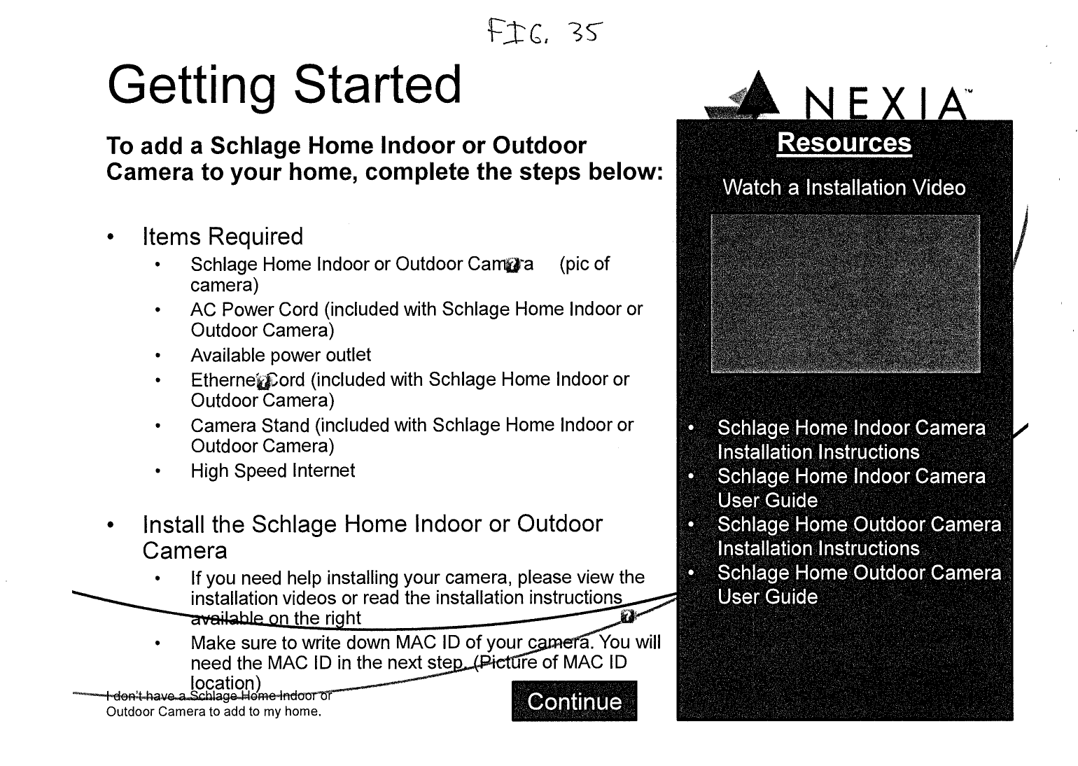

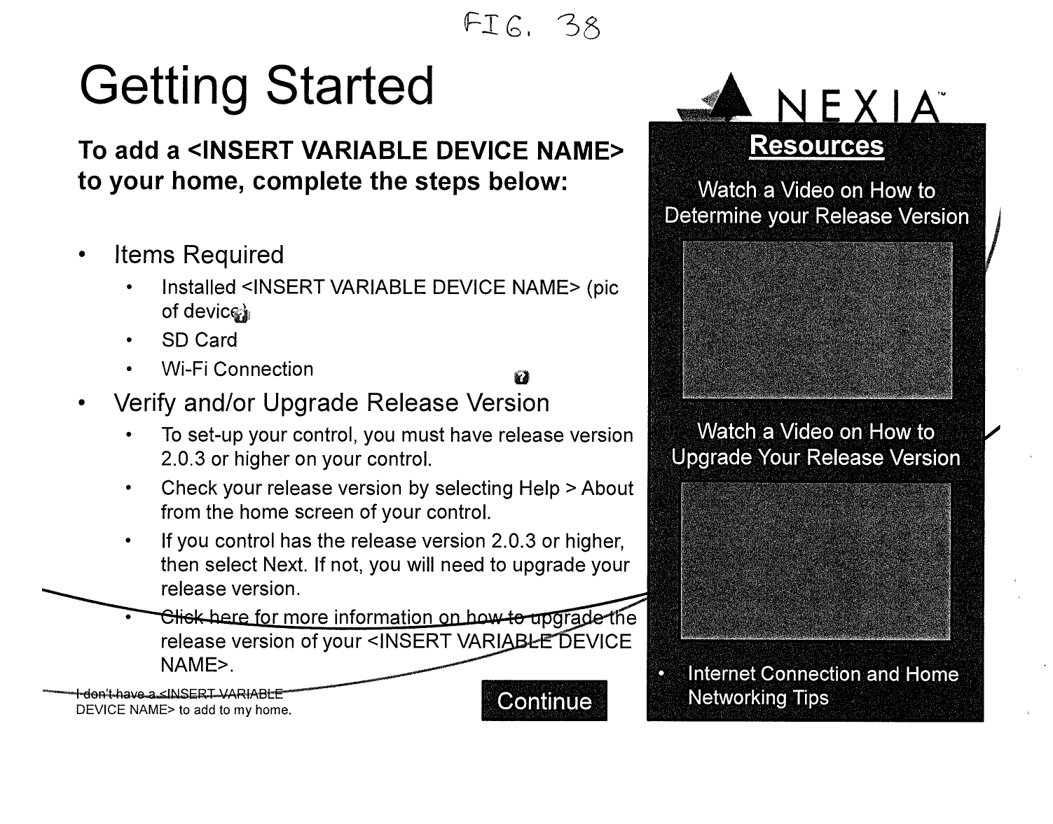

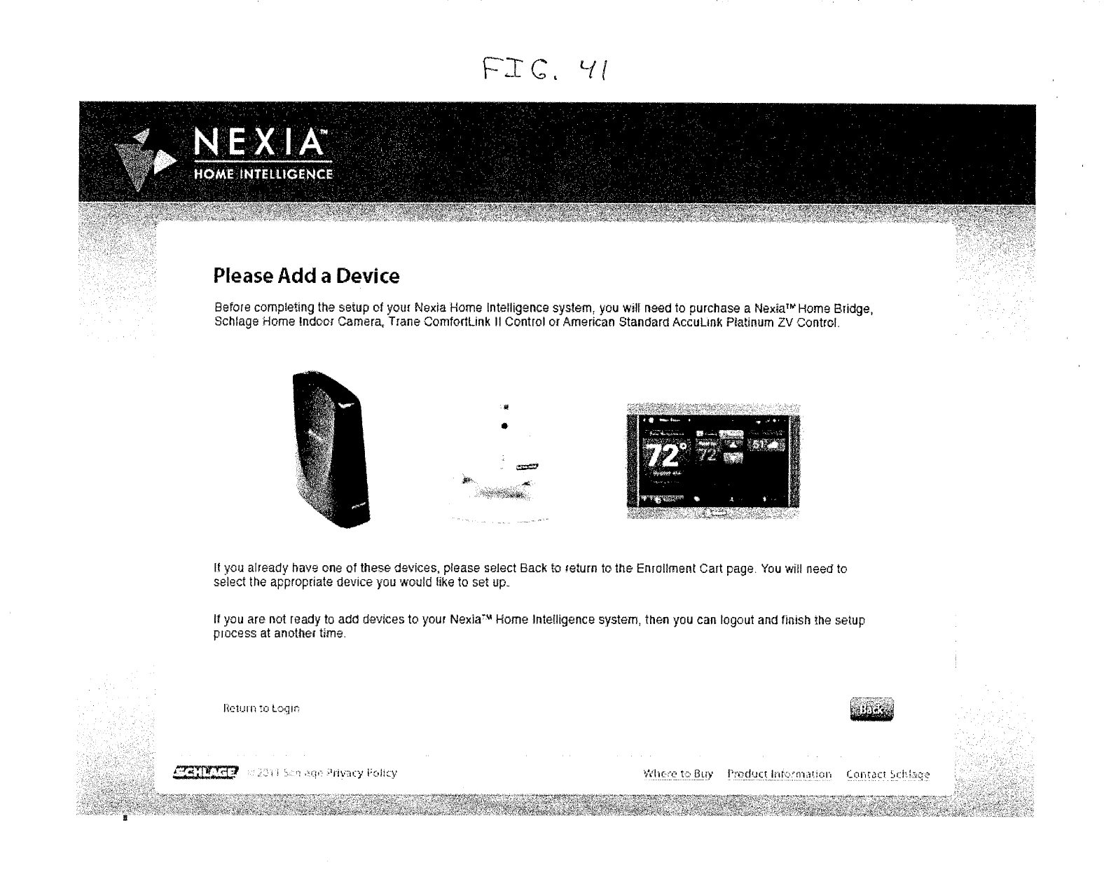

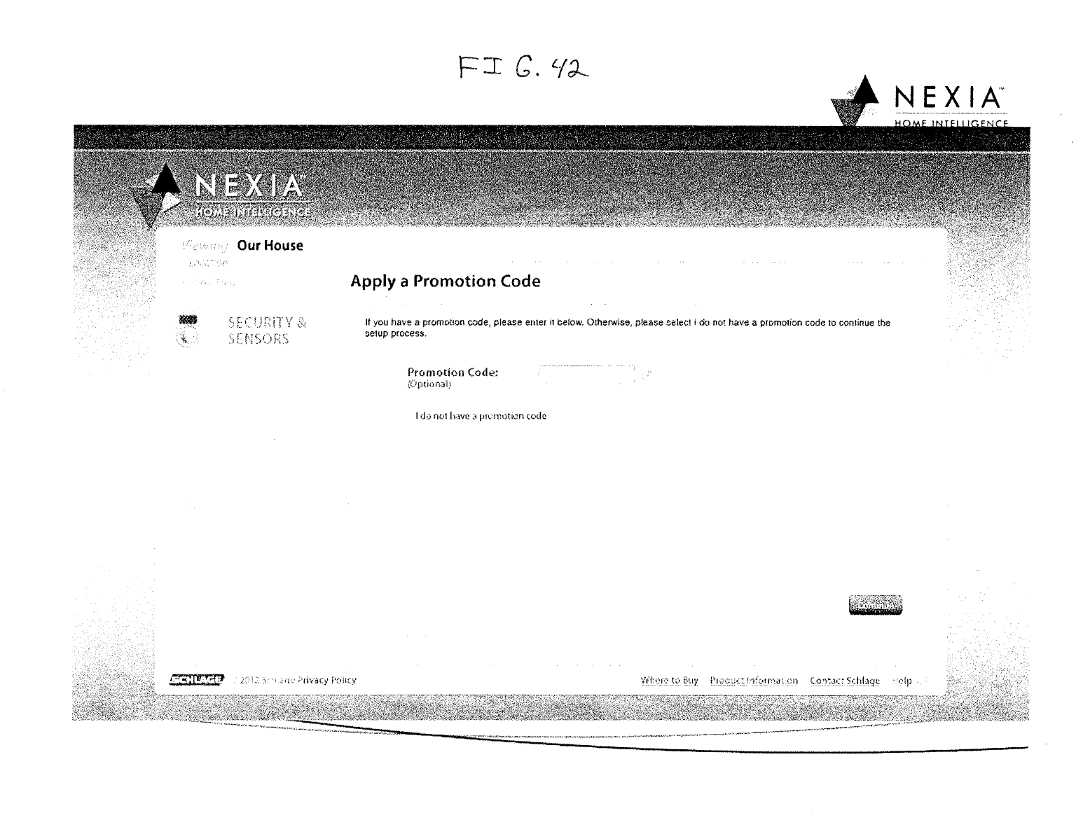

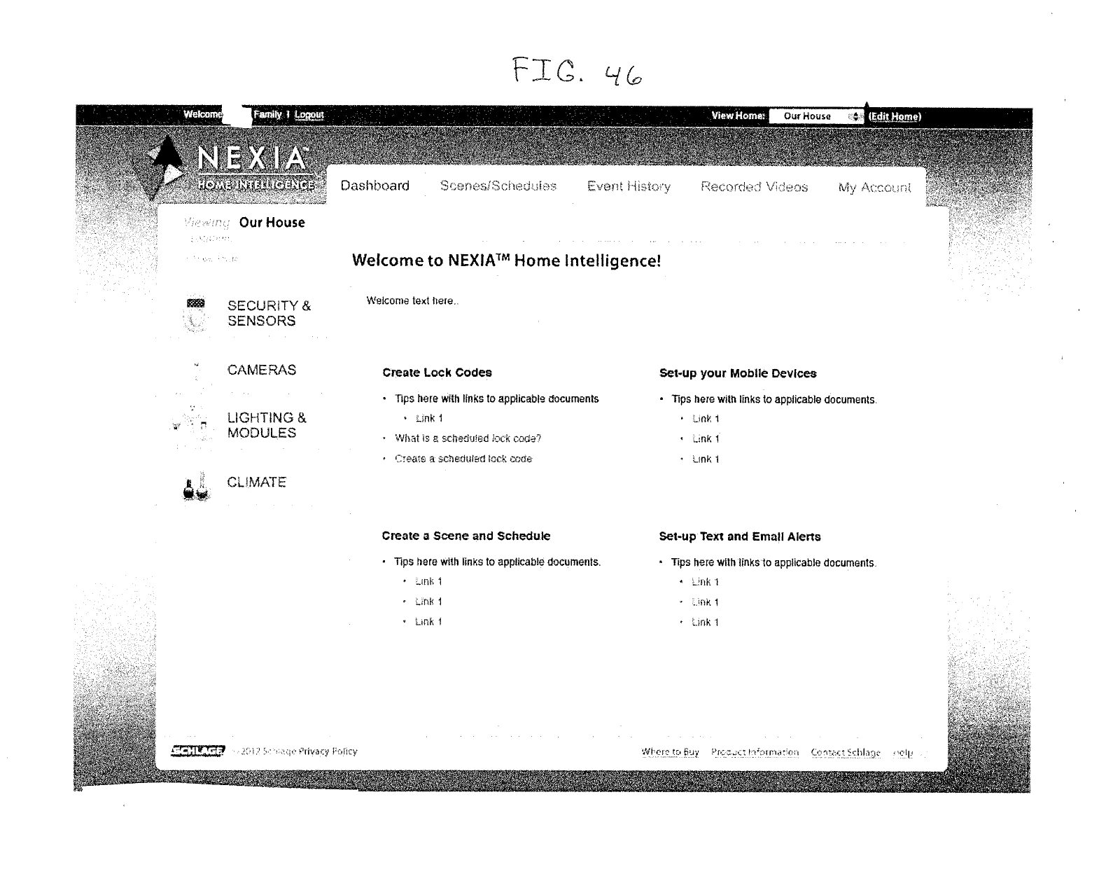

FIGS. 7-46 illustrate a technique 700 for setting up an account and/or installing devices 106 in a network 108. FIG. 7 illustrates a login page. FIG. 8 illustrates a terms and conditions page. FIG. 9 illustrates an account setup page. FIG. 10 illustrates another account setup page. FIG. 11 illustrates an account confirmation page. FIG. 12 illustrates a confirmation email. FIG. 13 illustrates an account login page. FIG. 14 illustrates an add home page. FIG. 15 illustrates an enrollment cart page. FIG. 16 illustrates an enrollment cart confirmation page. FIG. 17 illustrates a getting started page. FIG. 18 illustrates a device enrollment instruction page. FIG. 19 illustrates a enrollment confirmation page. FIGS. 20-23 illustrate pages, including resources and tooltips, that may be part of a bridge module. FIGS. 24-26 illustrate pages, including resources and tooltips, that may be part of a light module. FIGS. 27-29 illustrate pages, including resources and tooltips, that may be part of a thermostat module. FIGS. 30-32 illustrate pages, including resources and tooltips, that may be part of a lock module. FIGS. 33-34 illustrate pages, including resources and tooltips, that may be part of a sensor module. FIGS. 35-37 illustrate pages, including resources and tooltips, that may be part of a camera module. FIGS. 38-40 illustrate pages, including resources and tooltips, that may be part of a XL 950 module. FIG. 41 illustrates an add device page. FIGS. 42-45 illustrate billing pages. FIG. 46 illustrates a welcome page.

Any of the pages illustrated in FIGS. 7-46 may be implemented as web pages, which may be hosted by the server 114 and displayed and interacted with using the computer 102. It is also contemplated that the pages in FIGS. 7-46 may be pages in a software program on a computer or the like, or the pages may be in an app in a mobile device such as a smart phone. It is contemplated that any of the modules 312 shown in FIGS. 20-40 may be used in any of the techniques 350, 400, 500, 600, or 700.

The various account setup and/or device installation processes described above may decrease call volume related to installation and account setup. Moreover, the account setup and/or device installation processes may increase overall customer satisfaction, installation satisfaction, and account setup satisfaction.

One aspect of the present application may include a method, comprising: presenting, with a computer, a plurality of devices a user can select to be installed in a home automation system; determining an order of installation of the devices based on a type of a selected device; and presenting one or more modules in the order of installation, wherein each module corresponds to a selected one of the devices and includes instructions for installation.

Features of the aspect of the present application may include: presenting one or more error messages related to a particular module, wherein each error message includes instructions for resolving the error; presenting one or more tooltips related to a particular module; wherein each module includes at least one resource; and/or tracking a progress of the installation of the devices; and recording the progress in a database on a server.

Another aspect of the present application may include an apparatus, comprising: means for presenting a plurality of devices a user can select to be installed in a home automation system; means for determining an order of installation of the devices based on a type of a selected device; and/or means for presenting one or more modules in the order of installation, wherein each module corresponds to a selected one of the devices and includes instructions for installation.

Features of the aspect of the present application may include: means for presenting one or more error messages related to a particular module, wherein each error message includes instructions for resolving the error; means for presenting one or more tooltips related to a particular module; wherein each module includes at least one resource; means for tracking a progress of the installation of the devices; and/or means for recording the progress in a database on a server.

Yet another aspect of the present application may include an apparatus, comprising: an enrollment cart section to present a plurality of devices a user can select to be installed in a home automation system; a set-up logic section to determine an order of installation of the devices based on a type of a selected device; and a module section to present one or more modules in the order of installation, wherein each module corresponds to a selected one of the devices and includes instructions for installation.

Features of the aspect of the present application may include: an error message section to present one or more error messages related to a particular module, wherein each error message includes instructions for resolving the error; a help section to present one or more tooltips related to a particular module; and/or wherein each module includes at least one resource.

Another aspect of the present application may include a method, comprising: presenting, with a server, a plurality of devices a user can select to be installed in a building automation system; receiving, with the server, a user selection of devices to be installed in the building automation system, wherein the user selection of devices includes at least one AC-powered device and at least one battery-powered device; determining, with the server, an order of installation of the devices based on a type of device from the user selection of devices, wherein the at least one AC-powered device is listed before the at least one battery-powered device in the order of installation; and presenting a plurality of modules in the order of installation, wherein each module corresponds to one device from the user selection of devices and includes instructions for installation.

Yet another aspect of the present application may include an apparatus, comprising: an enrollment cart section to present a plurality of devices a user can select to be installed in a building automation system; a set-up logic section to determine an order of installation of the devices based on a type of selected devices, wherein the selected devices include an AC-powered device and a battery-powered device, and wherein the AC-powered device is listed before the battery-powered device in the order of installation; and a module section to present one or more modules in the order of installation, wherein each module corresponds to one of the selected devices and includes instructions for installation.

Another aspect of the present application may include a method, comprising: receiving a user input that includes an indication of a plurality of automation devices to be setup in a building; classifying the devices according to either a WIFI category or a mesh network category; subclassifying the devices in the mesh network category into an AC-powered category and a battery-powered category; determining an order of setup based on the classifying and subclassifying steps; and presenting a setup module for each device to be installed, wherein the setup modules are presented according to the order of setup, wherein setup modules for devices in the AC-powered category are presented before setup modules for devices in the battery-powered category.

Yet another aspect of the present application may include an apparatus, comprising: one or more servers communication with a plurality of customer computers, wherein the one or more servers are configured with non-transitory computer executable instructions to receive a user input that includes an indication of a plurality of automation devices to be setup in a building, to classify the devices according to either a WIFI category or a mesh network category, to subclassify the devices in the mesh network category into an AC-powered category and a battery-powered category, to determine an order of setup based on the classifying and subclassifying, and to present a setup module for each device to be installed, wherein the setup modules are presented according to the order of setup, wherein setup modules for devices in the AC-powered category are presented before setup modules for devices in the battery-powered category.

Another aspect of the present application includes a method, comprising: presenting, with a server, a plurality of devices a user can select to be installed in a building automation system; receiving, with the server, a user selection of devices to be installed in the building automation system; determining, with the server, an order of installation of the devices based on a communication pattern of each device from the user selection of devices; and presenting a plurality of modules in the order of installation, wherein each module corresponds to one device from the user selection of devices and includes instructions for installation.

Features of the aspect of the present application may include: presenting one or more error messages related to a particular module, wherein each error message includes instructions for resolving the error; presenting one or more tooltips related to a particular module; wherein each module includes at least one resource; tracking a progress of the installation of the devices; and recording the progress in a database on a server; wherein the building is at least one of a residential building and a commercial building; wherein the user selection of devices includes at least one AC-powered device and at least one battery-powered device that are part of a mesh network, and wherein the at least one AC-powered device is listed before the at least one battery-powered device in the order of installation; presenting a WIFI-device module for a WIFI device after the presenting modules for the at least one AC-powered device and the at least one battery-powered device; wherein the AC-powered device includes at least one of a bridge, a light control module, an appliance module, and a thermostat, and wherein the battery-powered device includes at least one of a sensor and a lock; presenting modules for devices that act as repeaters in a mesh network before presenting modules for devices that do not act as repeaters in the mesh network.

Yet another aspect of the present application may include an apparatus, comprising: an enrollment cart section to present a plurality of devices a user can select to be installed in a building automation system; a set-up logic section to determine an order of installation of the devices based on a type of selected devices; and a module section to present one or more modules in the order of installation, wherein each module corresponds to one of the selected devices and includes instructions for installation, and wherein each module includes at least one resource.

Features of the aspect of the present application may include: an error message section to present one or more error messages related to a particular module, wherein each error message includes instructions for resolving the error; wherein in the order of installation, modules for devices that act as repeaters in a mesh network are listed before modules for devices that do not act as repeaters in the mesh network; wherein the selected devices include an AC-powered device and a battery-powered device, and wherein the AC-powered device is listed before the battery-powered device in the order of installation; a tracking section to track a progress of the installation of the devices and to record the progress in a database on a server.

Another aspect of the present application may include a method, comprising: receiving a user input that includes an indication of a plurality of automation devices to be setup in a building; classifying the devices according to either a WIFI category or a mesh network category; subclassifying the devices in the mesh network category into a plurality of subcategories; determining an order of setup based on the classifying and subclassifying steps; and presenting a setup module for each device to be installed, wherein the setup modules are presented according to the order of setup.

Features of the aspect of the present application may include: wherein the plurality of subcategories includes an AC-powered subcategory and a battery-powered subcategory, and wherein setup modules for devices in the AC-powered category are presented before setup modules for devices in the battery-powered category; wherein the setup modules for devices in the WIFI category are presented after the setup modules for devices in the mesh network category; wherein the plurality of subcategories includes a repeater subcategory and a non-repeater subcategory, and wherein setup modules for devices in the repeater subcategory are presented before setup modules for devices in the non-repeater subcategory.

Yet another aspect of the present application may include: one or more servers communication with a customer computer, wherein the one or more servers are configured with non-transitory computer executable instructions to receive a user input that includes an indication of a plurality of automation devices to be setup in a building, to classify the devices according to either a WIFI category or a mesh network category, to subclassify the devices in the mesh network category into a plurality of subcategories, to determine an order of setup based on the classifying and subclassifying, and to present a setup module for each device to be installed, wherein the setup modules are presented according to the order of setup.

Features of the aspect of the present application may include: wherein the one or more servers are further configured to present the setup modules for devices in the WIFI category after the setup modules for devices in the mesh network category; wherein the plurality of subcategories includes an AC-powered subcategory and a battery-powered subcategory, and wherein setup modules for devices in the AC-powered category are presented before setup modules for devices in the battery-powered category; wherein the plurality of subcategories includes a repeater subcategory and a non-repeater subcategory, and wherein setup modules for devices in the repeater subcategory are presented before setup modules for devices in the non-repeater subcategory.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A method, comprising:
presenting, with a server, a plurality of devices a user can select to be installed in a building automation system;
receiving, with the server, a user selection of devices to be installed in the building automation system;
determining, with the server, an order of installation of the devices based on a communication pattern of each device from the user selection of devices; and
presenting a plurality of modules in the order of installation, wherein each module corresponds to one device from the user selection of devices and includes instructions for installation.

2. The method of claim 1, further comprising:
presenting one or more error messages related to a particular module, wherein each error message includes instructions for resolving the error.

3. The method of claim 1, further comprising:
presenting one or more tooltips related to a particular module.

4. The method of claim 1, wherein each module includes at least one resource.

5. The method of claim 1, further comprising:
tracking a progress of the installation of the devices; and
recording the progress in a database on a server.

6. The method of claim 1, wherein the building is at least one of a residential building and a commercial building.

7. The method of claim 1, wherein the user selection of devices includes at least one AC-powered device and at least one battery-powered device that are part of a mesh network, and wherein the at least one AC-powered device is listed before the at least one battery-powered device in the order of installation.

8. The method of claim 7, further comprising:
presenting a WIFI-device module for a WIFI device after the presenting modules for the at least one AC-powered device and the at least one battery-powered device.

9. The method of claim 7, wherein the AC-powered device includes at least one of a bridge, a light control module, an appliance module, and a thermostat, and wherein the battery-powered device includes at least one of a sensor and a lock.

10. The method of claim 1, further comprising:
presenting modules for devices that act as repeaters in a mesh network before presenting modules for devices that do not act as repeaters in the mesh network.

11. An apparatus, comprising:
an enrollment cart section to present a plurality of devices a user can select to be installed in a building automation system;
a set-up logic section to determine an order of installation of the devices based on a type of selected devices; and
a module section to present one or more modules in the order of installation, wherein each module corresponds to one of the selected devices and includes instructions for installation, and wherein each module includes at least one resource.

12. The apparatus of claim 11, further comprising:
an error message section to present one or more error messages related to a particular module, wherein each error message includes instructions for resolving the error.

13. The apparatus of claim 11, wherein in the order of installation, modules for devices that act as repeaters in a mesh network are listed before modules for devices that do not act as repeaters in the mesh network.

14. The apparatus of claim 11, wherein the selected devices include an AC-powered device and a battery-powered device, and wherein the AC-powered device is listed before the battery-powered device in the order of installation.

15. The apparatus of claim 11, further comprising:
a tracking section to track a progress of the installation of the devices and to record the progress in a database on a server.

16. A method, comprising:
receiving a user input that includes an indication of a plurality of automation devices to be setup in a building;
classifying the devices according to either a WIFI category or a mesh network category;
subclassifying the devices in the mesh network category into a plurality of subcategories;
determining an order of setup based on the classifying and subclassifying steps; and
presenting a setup module for each device to be installed, wherein the setup modules are presented according to the order of setup.

17. The method of claim 16, wherein the plurality of subcategories includes an AC-powered subcategory and a battery-powered subcategory, and wherein setup modules for devices in the AC-powered category are presented before setup modules for devices in the battery-powered category.

18. The method of claim 16, wherein the setup modules for devices in the WIFI category are presented after the setup modules for devices in the mesh network category.

19. The method of claim of claim 16, wherein the plurality of subcategories includes a repeater subcategory and a non-repeater subcategory, and wherein setup modules for devices in the repeater subcategory are presented before setup modules for devices in the non-repeater subcategory.

20. An apparatus, comprising:
one or more servers communication with a customer computer, wherein the one or more servers are configured with non-transitory computer executable instructions to receive a user input that includes an indication of a plurality of automation devices to be setup in a building, to classify the devices according to either a WIFI category or a mesh network category, to subclassify the devices in the mesh network category into a plurality of subcategories, to determine an order of setup based on the classifying and subclassifying, and to present a setup module for each device to be installed, wherein the setup modules are presented according to the order of setup.

21. The apparatus of claim 20, wherein the one or more servers are further configured to present the setup modules for devices in the WIFI category after the setup modules for devices in the mesh network category.

22. The apparatus of claim 20, wherein the plurality of subcategories includes an AC-powered subcategory and a battery-powered subcategory, and wherein setup modules for devices in the AC-powered category are presented before setup modules for devices in the battery-powered category.

23. The apparatus of claim 20, wherein the plurality of subcategories includes a repeater subcategory and a non-repeater subcategory, and wherein setup modules for devices in the repeater subcategory are presented before setup modules for devices in the non-repeater subcategory.
